(19) United States
(12) Patent Application Publication
(10) Pub. No.: US 2026/0135607 A1
(43) Pub. Date: May 14, 2026

(54) BEAM PREDICTION METHOD AND APPARATUS, AND DEVICE AND STORAGE MEDIUM

(71) Applicant: Beijing Xiaomi Mobile Software Co., Ltd., Beijing (CN)

(72) Inventors: Mingju LI, Beijing (CN); Zhongyuan ZHAO, Beijing (CN); Jingyi WANG, Beijing (CN)

(21) Appl. No.: 19/119,848

(22) PCT Filed: Oct. 10, 2022
(86) PCT No.: PCT/CN2022/124468

§ 371 Date: Apr. 10, 2025

(51) Int. Cl. H04B 7/06

(52) U.S. Cl. CPC H04B 7/0696

(57) ABSTRACT

A beam prediction method is performed by a terminal and includes: determining beam quality of partial beam pairs in first receiving beam groups, wherein the first receiving beam groups belong to receiving beam groups corresponding to receiving beams supported by the terminal; and predicting an optimal beam or beam quality of all beam pairs in the first receiving beam groups by inputting the beam quality of the partial beam pairs in the first receiving beam groups into a beam prediction model; wherein the beam prediction model is obtained through pre-training based on beam quality of beam pairs in second receiving beam groups, the second receiving beam groups belong to the receiving beam groups corresponding to the receiving beams supported by the terminal, and the second receiving beam groups are same as or different from the first receiving beam groups.

### CROSS REFERENCE TO RELATED APPLICATION

This application is a US National Stage of International Application No. PCT/CN2022/124468, filed on Oct. 10, 2022, the content of which is incorporated by reference herein in its entirety.

### TECHNICAL FIELD

The present disclosure relates to the field of communication technology, and in particular to a method, an apparatus, a device and a storage medium for beam prediction.

### BACKGROUND

In new radio (NR), especially when the communication frequency band is in frequency range 2, beam-based transmission and reception are required to ensure coverage due to the rapid attenuation of high-frequency channels.

Beam management can select the optimal beam to ensure the interaction quality between network devices and terminals by measuring beam pairs in different directions. 5G NR greatly improves the coverage capability of wireless networks in the millimeter wave frequency band through beam management technology. In the traditional beam management process, the network device will configure a reference signal resource set for beam measurement. The terminal measures the reference signal resources in the reference signal resource set and then reports one or more stronger reference signal resource identifiers and the corresponding reference signal beam quality. In related art, the terminal needs to measure the reference signal for each beam pair, which is constituted by a receiving beam and a transmitting beam.

With the continuous development of wireless networks, various services have increasing requirements for beam performance. If the number of analog beams is large, the gain of analog beamforming can be improved, but the overhead of beam measurement and the complexity of beam management are increased. If the number of analog beams is small, the gain of analog beamforming will be affected. Therefore, how to improve the efficiency of beam management to reduce the number of beam pairs that the terminal needs to measure and make beam management more efficient has become an urgent problem to be solved.

### SUMMARY

According to a first aspect of embodiments of the present disclosure, a beam prediction method is provided, which is applied to a terminal and includes: determining beam quality of partial beam pairs in first receiving beam groups, where the first receiving beam groups are partial receiving beam groups in receiving beam groups corresponding to receiving beams supported by the terminal; and predicting an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to a second aspect of embodiments of the present disclosure, a beam prediction method is provided, which is applied to a network device and includes: receiving beam quality of partial beam pairs in first receiving beam groups sent by a terminal, where the first receiving beam groups are partial receiving beam groups in receiving beam groups corresponding to receiving beams supported by the terminal; and predicting an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to a third aspect of embodiments of the present disclosure, a beam prediction apparatus is provided, which is equipped in a terminal and includes: a determining module, configured to determine beam quality of partial beam pairs in first receiving beam groups, where the first receiving beam groups are partial receiving beam groups in receiving beam groups corresponding to receiving beams supported by the terminal; and a predicting module, configured to predict an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to a fourth aspect of embodiments of the present disclosure, a beam prediction apparatus is provided, which is equipped in a network device and includes: a receiving module, configured to receive beam quality of partial beam pairs in first receiving beam groups sent by a terminal, where the first receiving beam groups are partial receiving beam groups in receiving beam groups corresponding to receiving beams supported by the terminal; and a predicting module, configured to predict an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to a fifth aspect of embodiments of the present disclosure, a beam prediction device is provided, including: a processor; a memory configured to store instructions executable by the processor; where the processor is configured to implement any one of the methods according to the first aspect.

According to a sixth aspect of embodiments of the present disclosure, a beam prediction device is provided, including: a processor; a memory configured to store instructions executable by the processor; where the processor is configured to implement any one of the methods according to the second aspect.

According to a seventh aspect of embodiments of the present disclosure, a non-transitory computer-readable storage medium is provided, where, when instructions in the storage medium are executed by a processor of a terminal, the terminal is caused to implement any one of the methods according to the first aspect.

According to an eighth aspect of embodiments of the present disclosure, a non-transitory computer-readable storage medium is provided, where, when instructions in the storage medium are executed by a processor of a terminal, the terminal is caused to implement any one of the methods according to the second aspect.

The technical solution according to some embodiments of the present disclosure may have the following beneficial effects. By using the beam prediction model obtained by training with the beam quality of a small number of beam pairs, the optimal beam and/or the beam quality of all beam pairs can be predicted based on the beam quality of some measured beam pairs, thereby reducing the overhead and delay of beam management. In addition, it is also applicable to terminals that support different receiving beams, and has a wider range of applications.

It is to be understood that the foregoing general description and the following detailed description are exemplary and explanatory only, and are not restrictive of the present disclosure.

### BRIEF DESCRIPTION OF THE DRAWINGS

The accompanying drawings, which are incorporated in and constitute a part of this specification, illustrate some embodiments consistent with the present disclosure and, together with the description, serve to explain the principles of the present disclosure.

FIG. 1 is a schematic diagram of a wireless communication system according to an exemplary embodiment.

FIG. 2 is a flow chart of a beam prediction method according to an exemplary embodiment.

FIG. 3 is a flow chart of another beam prediction method according to an exemplary embodiment.

FIG. 4 is a flow chart of yet another beam prediction method according to an exemplary embodiment.

FIG. 5 is a flow chart of yet another beam prediction method according to an exemplary embodiment.

FIG. 6 is a flow chart of another beam prediction method according to an exemplary embodiment.

FIG. 7 is a flow chart of yet another beam prediction method according to an exemplary embodiment.

FIG. 8 is a flow chart of yet another beam prediction method according to an exemplary embodiment.

FIG. 9 is a flow chart of another beam prediction method according to an exemplary embodiment.

FIG. 10 is a flow chart of yet another beam prediction method according to an exemplary embodiment.

FIG. 11 is a flow chart of yet another beam prediction method according to an exemplary embodiment.

FIG. 12 is a flow chart of another beam prediction method according to an exemplary embodiment.

FIG. 13 is a flow chart of yet another beam prediction method according to an exemplary embodiment.

FIG. 14 is a flow chart of yet another beam prediction method according to an exemplary embodiment.

FIG. 15 is a flow chart of another beam prediction method according to an exemplary embodiment.

FIG. 16 is a flow chart of yet another beam prediction method according to an exemplary embodiment.

FIG. 17 is a schematic diagram of beam prediction model training according to an exemplary embodiment.

FIG. 18 is a schematic diagram of beam prediction model prediction according to an exemplary embodiment.

FIG. 19 is a schematic diagram of another beam prediction model training according to an exemplary embodiment.

FIG. 20 is a schematic diagram of another beam prediction model prediction according to an exemplary embodiment.

FIG. 21 is a schematic diagram of a beam prediction apparatus according to an exemplary embodiment.

FIG. 22 is a schematic diagram of another beam prediction apparatus according to an exemplary embodiment.

FIG. 23 is a schematic diagram of a beam prediction device according to an exemplary embodiment.

FIG. 24 is a schematic diagram of another beam prediction device according to an exemplary embodiment.

### DETAILED DESCRIPTION

Here, exemplary embodiments will be described in detail, examples of which are shown in the accompanying drawings. When the following description refers to the drawings, unless otherwise indicated, the same numbers in different drawings represent the same or similar elements. The implementations described in the following exemplary embodiments do not represent all implementations consistent with the present disclosure.

The communication method involved in the present disclosure can be applied to the wireless communication system 100 shown in FIG. 1. The network system may include a network device 110 and a terminal 120. It can be understood that the wireless communication system shown in FIG. 1 is only for schematic illustration, and the wireless communication system may also include other network devices, for example, core network devices, wireless relay devices, and wireless backhaul devices, which are not shown in FIG. 1. Embodiments of the present disclosure do not limit the number of network devices and the number of terminals included in the wireless communication system.

It can be further understood that the wireless communication system according to some embodiments of the present disclosure is a network that provides wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency division multiple access (OFDMA), single carrier frequency division multiple access (SC-FDMA), carrier sense multiple access/collision avoidance. According to the capacity, rate, delay and other factors of different networks, the network can be divided into 2G (generation) network, 3G network, 4G network or future evolution network, such as 5G (The 5-th Generation Wireless Communication System) network. 5G network can also be called new radio (NR). For the convenience of description, the present disclosure sometimes simply refers to a wireless communication network as a network.

Further, the network device 110 involved in the present disclosure may also be referred to as a wireless access network device. The wireless access network device may be: a base station, an evolved node B (eNB), a home base station, an access point (AP) in a wireless fidelity (WIFI) system, a wireless relay node, a wireless backhaul node, a transmission point (TP), or the like. It may also be a gNB in the NR system, or it may also be a component or a part of a base station. In addition, when a vehicle-to-everything (V2X) communication system is involved, the network device may also be a vehicle-mounted device. It should be understood that in some embodiments of the present disclosure, the specific technology and specific device form adopted by the network device are not limited.

Furthermore, the terminal 120 involved in the present disclosure may also be referred to as a terminal device, a user equipment (UE), a mobile station (MS), a mobile terminal (MT), or the like, which is a device that provides voice and/or data connectivity to users. For example, the terminal may be a handheld device with a wireless connection function, a vehicle-mounted device, or the like. At present, some examples of terminals include: a smart mobile phone, a pocket personal computer (PPC), a handheld computer, a personal digital assistant (PDA), a laptop computer, a tablet computer, a wearable device, a vehicle-mounted device, or the like. In addition, when a vehicle-to-everything (V2X) communication system is involved, the terminal device may also be a vehicle-mounted device. It should be understood that the embodiments of the present disclosure do not limit the specific technology and specific device form adopted by the terminal.

In the embodiments of the present disclosure, the network device 110 and the terminal 120 may use any feasible wireless communication technology to achieve mutual data transmission. Herein, the transmission channel corresponding to the data sent by the network device 110 to the terminal 120 is called a downlink channel (DL), and the transmission channel corresponding to the data sent by the terminal 120 to the network device 110 is called an uplink channel (UL). It can be understood that the network device involved in the embodiments of the present disclosure may be a base station. Also, the network device may be any other possible network device, and the terminal may be any possible terminal, which is not limited by the present disclosure.

In new radio (NR), especially when the communication frequency band is in the frequency range 2, due to the rapid attenuation of high-frequency channels, in order to ensure the coverage performance and coverage range of the wireless network in the millimeter wave frequency band, beam-based transmission and reception are required. For example, network devices and terminals interact through formed beams with narrow angles. Beam management can measure beam pairs in different directions and select the optimal beam to ensure the interaction quality between network devices and terminals. In 5G NR, the coverage capability of wireless networks is greatly improved in the millimeter wave frequency band through beam management technology. In order to ensure beam management performance while further reducing terminal overhead, the beam management mechanism has become an important topic that needs to be studied urgently.

In order to better standardize 5G NR beam management technology, the 3rd Generation Partnership Project (3GPP) launched a research project on beam management at the meetings #90 and #91 of Radio Access Network (RAN) 1, in which the basic components of beam management were standardized, for example, including followings.

Beam scanning refers to achieving coverage in a specific area using beams in different directions in a time-division multiplexing manner, where each beam carries signals such as the channel state information reference signal (CSI-RS) and the synchronization signal/physical broadcast channel (PBCH) block (SSB). After beam scanning, users can obtain the signals carried by beams in different directions.

Beam measurement refers to that the terminal measures the reference signal carried by the receiving beam and obtains the beam quality in that direction by calculating the signal quality of the reference signal.

Beam reporting refers to that the terminal reports the measurement information of the reference signal carried by the beam, where the measurement information includes at least the reference signal identifier and the corresponding measurement quality. The measurement quality may include layer-1 reference signal received power (L1-RSRP) and/or layer-1 signal to interference plus noise ratio (L1-SINR). The identifier may be, for example, an identity (ID) or an index.

Beam determination refers to that the network device and the terminal select the transmitting/receiving beam(s). In the connected state, the network device shall determine the transmitting beam based on the measurement information fed back by the terminal and indicate the beam to the terminal.

With the continuous development of wireless networks, various services have increasing requirements for beam performance. If the number of simulated beams is large, the gain of simulated beamforming will be improved, but the overhead of beam measurement and the complexity of beam management will be increased. If the number of simulated beams is small, the gain of simulated beamforming will be affected. In order to improve the efficiency of beam management, beam prediction based on artificial intelligence (AI) technology is considered to reduce the number of beam pairs that the user side needs to measure and make beam management more efficient.

In the related art, in the traditional beam management procedure, the network device will configure a reference signal resource set for beam measurement. The terminal measures the reference signal resources in the reference signal resource set, and then reports the identifier(s) of one or more relatively strong reference signal resource as well as the corresponding reference signal measurement quality. The terminal needs to measure the reference signal for each beam pair. Herein, a beam pair is constituted by a receiving beam and a transmitting beam.

For example, assuming that there are M transmitting beams on the network device side, with each transmitting beam corresponding to a reference signal; and there are N receiving beams on the terminal side, so there are a total of M×N beam pairs. If all these M×N beam pairs are measured, a large amount of reference signal resources will be consumed and huge delays will be caused. Therefore, if the measurement quality of only a few beam pairs is to be measured, and the measurement quality of M×N beam pairs can be restored based thereon, the overhead and delay of beam management can be effectively reduced while ensuring the performance of beam management.

In the related art, a method for training and deriving a beam prediction model based on a fixed number of receiving beams is provided. For example, when performing beam prediction, the beam quality used for training and deriving the beam prediction model is collected based on a fixed number of receiving beams. The network device sends a CSI-RS/SSB reference signal to the terminal, and the terminal performs CSI-RS/SSB measurement to obtain the beam quality on each beam pair. The beam prediction model is then trained using the obtained beam quality, so as to restore the beam quality of all beam pairs based on the beam quality of a small number of beam pairs. When the model is deduced, the beam pairs used as basis are consistent with the beam pairs used during training.

Accordingly, in the above manner, the changes in the number of receiving beams supported by the terminal are not taken into account. For example, different terminals may support different numbers of receiving beams. For terminals with different numbers of receiving beams, the number of transmitting and receiving beam pairs (hereinafter referred to as beam pairs) is also different. Therefore, the identifiers and/or numbers of beam pairs corresponding to input and output of the beam prediction model may vary, where the identifier may be, for example, an ID or an index. The beam prediction model in the above manner cannot adapt to a variety of different inputs and outputs, cannot meet diverse service requirements, and has poor generalization performance.

Therefore, how to improve the efficiency of beam management to reduce the number of beam pairs that the terminal needs to measure and make beam management more efficient has become an urgent problem to be solved.

According to the present disclosure, a beam prediction model, trained by using the beam quality of a small number of beam pairs, is used to predict the beam quality of all beam pairs and/or the optimal beam based on the beam quality of some measured beam pairs, thereby reducing the overhead and delay of beam management. It is also applicable to terminals that support different receiving beams, and has a wider range of applications.

FIG. 2 is a flow chart of a beam prediction method according to an exemplary embodiment. As shown in FIG. 2, the method is applied to a terminal and may include the following steps.

In step S11, beam quality of partial beam pairs in first receiving beam groups is determined.

In some embodiments, the terminal may determine the beam quality of some beam pairs in first receiving beam groups, where the first receiving beam groups are partial receiving beam groups in receiving beam groups corresponding to receiving beams supported by the terminal.

For example, the receiving beams supported by the terminal are receiving beam 1, receiving beam 2, receiving beam 3 and receiving beam 4. Each receiving beam may correspond to one receiving beam group. For example, receiving beam 1 corresponds to receiving beam group 1, receiving beam 2 corresponds to receiving beam group 2, receiving beam 3 corresponds to receiving beam group 3, and receiving beam 4 corresponds to receiving beam group 4. The first receiving beam groups may be some receiving beam groups among receiving beam group 1, receiving beam group 2, receiving beam group 3 and receiving beam group 4. For example, the first receiving beam groups may be receiving beam group 1 and receiving beam group 2; for another example, the first receiving beam groups may be receiving beam group 1 and receiving beam group 3; for another example, the first receiving beam groups may be receiving beam group 1, receiving beam group 2 and receiving beam group 4; and so on.

It can be understood that the receiving beam groups corresponding to the first receiving beam groups can be predefined.

In step S12, the beam quality of the partial beam pairs in the first receiving beam groups are input into a beam prediction model to predict an optimal beam and/or beam quality of all beam pairs in the first receiving beam groups.

In some embodiments, the terminal may input the beam quality of the partial beam pairs in the first receiving beam groups determined in S11 into the beam prediction model, so as to predict the optimal beam and/or the beam quality of all beam pairs in the first receiving beam groups, where the beam prediction model is obtained through pre-training based on beam quality of beam pairs in second receiving beam groups. The second receiving beam groups are partial receiving beam groups in the receiving beam groups corresponding to the receiving beams supported by the terminal, and the second receiving beam groups are the same as or different from the first receiving beam groups.

For example, the receiving beams supported by the terminal are receiving beam 1, receiving beam 2, receiving beam 3 and receiving beam 4. Each receiving beam may correspond to one receiving beam group. For example, receiving beam 1 corresponds to receiving beam group 1, receiving beam 2 corresponds to receiving beam group 2, receiving beam 3 corresponds to receiving beam group 3, and receiving beam 4 corresponds to receiving beam group 4. The second receiving beam groups may be partial receiving beam groups among receiving beam group 1, receiving beam group 2, receiving beam group 3 and receiving beam group 4. For example, the second receiving beam groups may be receiving beam group 1 and receiving beam group 2; for another example, the second receiving beam groups may be receiving beam group 1 and receiving beam group 3; for another example, the second receiving beam groups may be receiving beam group 1, receiving beam group 2 and receiving beam group 4; and so on.

It can be understood that the receiving beam groups corresponding to the second receiving beam groups may be predefined. The second receiving beam groups and the first receiving beam groups may be the same one or more receiving beam groups, or may be different one or more receiving beam groups.

In some embodiments, when the beam prediction model is trained, all predefined second receiving beam groups may be used for training.

In some embodiments, the optimal beam may be a beam with the best beam quality when the terminal performs communication. The optimal beam may include at least one of an optimal transmitting beam, an optimal receiving beam, and an optimal beam pair. Here, the optimal beam pair includes a transmitting beam and a receiving beam. The beam quality of the beam may be considered to be the best when the beam quality meets a preset condition. The specific condition may be arbitrarily set according to actual situation, such as being higher than a certain threshold or lower than a certain threshold, or the like, which is not limited in this disclosure.

In some embodiments, the output of the beam prediction model may be the beam quality of all beam pairs in the first receiving beam groups. The output of the beam prediction model may be the beam quality of some beam pairs in the first receiving beam groups. The output of the beam prediction model may be the optimal beam corresponding to the first receiving beam groups.

According to the present disclosure, the beam prediction model, trained by using the beam quality of a small number of beam pairs, is used to predict the optimal beam and/or the beam quality of all beam pairs based on the beam quality of some measured beam pairs, thereby reducing the overhead and delay of beam management. It is also applicable to terminals that support different receiving beams, and has a wider range of applications.

In the beam prediction method according to some embodiments of the present disclosure, the number of first receiving beam groups are the same as or different from the number of second receiving beam groups; the number of first receiving beam groups is less than or equal to the number of receiving beam groups corresponding to the receiving beams supported by the terminal; and/or the number of second receiving beam groups is less than or equal to the number of receiving beam groups corresponding to the receiving beams supported by the terminal.

In some embodiments, it may be assumed that the number of receiving beams supported by the terminal is n, the number of first receiving beam groups may be recorded as n_test, and the number of second receiving beam groups may be recorded as n_train, where n_test and n_train may be the same or different.

In some embodiments, n_test is less than or equal to n, indicating that the terminal can perform beam prediction based on some or all receiving beams supported by the terminal.

In some embodiments, n_test may be divisible by n, and 1-n_test-n.

In some embodiments, n_train is less than or equal to n, indicating that the beam prediction model is trained using some receiving beams supported by the terminal.

In some embodiments, n_train may be divisible by n, and 1-n_train-n.

The beam prediction model in the present disclosure can use the same number or different numbers of receiving beam groups in the prediction stage and the training stage, so that the beam prediction groups are applicable to terminals supporting different numbers of receiving beams, thereby achieving a wider range of applications. Moreover, in the training stage of the beam prediction model, training can be completed by using only some of the receiving beam groups supported by the terminal, thereby reducing the overhead of beam management.

In the beam prediction method according to some embodiments of the present disclosure, the beam quality of partial beam pairs in the first receiving beam groups is determined based on the following parameters: a predefined sampling rate; and measurement mode information corresponding to the first receiving beam groups configured by the terminal.

In some embodiments, the terminal may determine the beam quality of partial beam pairs in the first receiving beam groups based on a predefined sampling rate and measurement mode information corresponding to the first receiving beam groups configured by the terminal.

For example, assuming that the network device has m transmitting beams, each receiving beam group has m beam pairs. Each first receiving beam group also has m beam pairs. Assuming the sampling rate is k, based on the predefined k, it can be determined that the beam quality of k*m beam pairs in the first receiving beam groups is to be measured. The measurement mode information corresponding to the first receiving beam groups configured by the terminal is indicative of which k*m beam pairs are determined from the m beam pairs in the first receiving beam groups according to the corresponding measurement mode. For example, the measurement mode may be uniform measurement, which is expressed as determining k*m beam pairs from the m beam pairs at fixed intervals. Alternatively, the specific measurement mode can be arbitrarily set according to actual situation, and the present disclosure is not limited thereto.

It can be understood that, the sampling rate k is a decimal between 0 and 1, or any value between 0 and 100%; and m is a positive integer.

In some embodiments, the sampling rate may be predefined by the terminal or the network device. If it is predefined by the terminal, the terminal may also send the sampling rate information to the network device. If it is predefined by the network device, the terminal may also receive the sampling rate information sent by the network device.

In some embodiments, the measurement mode information corresponding to the first receiving beam groups configured by the terminal is indicative of the measurement mode of the first receiving beam groups configured by the terminal. It can be understood that the measurement mode can be preset by the terminal.

According to the present disclosure, only some beam pairs in the first receiving beam groups are to be measured through the sampling rate and measurement mode, so that the prediction of other beam quality and/or the optimal beam can be achieved by using some beam pairs, thereby reducing the overhead and delay of beam management.

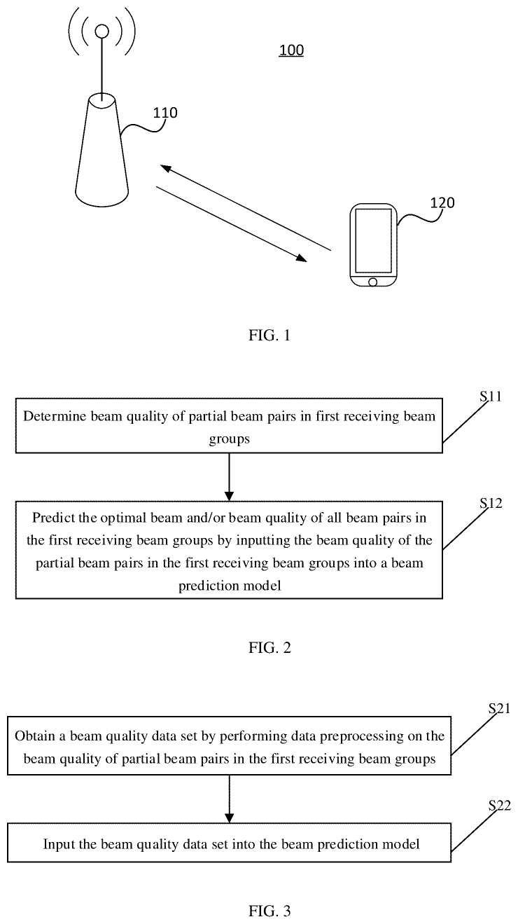

In the beam prediction method according to some embodiments of the present disclosure, FIG. 3 is a flow chart of another beam prediction method according to an exemplary embodiment. As shown in FIG. 3, in S12, inputting the beam quality of the partial beam pairs in the first receiving beam groups into the pre-trained beam prediction model may include the following steps.

In step S21, data preprocessing is performed on the beam quality of the partial beam pairs in the first receiving beam groups to obtain a beam quality data set.

In some embodiments, the terminal performs data preprocessing on the beam quality of partial beam pairs in the first receiving beam groups to obtain the beam quality data set, where the beam quality data set includes: a beam pair identifier; and beam quality corresponding to the beam pair identifier.

For example, the data preprocessing may include data inspection, data normalization, data set division, and the like. Herein, data inspection refers to performing preliminary screening of the beam quality of partial beam pairs within the first receiving beam groups, and eliminating obviously erroneous data, for example, obvious outliers. Data normalization can be used to ensure that the data structure input to the beam prediction model is the same, and data of different orders of magnitude can be normalized to the same order of magnitude, thereby reducing the computational complexity of the beam prediction model and improving the accuracy of the results. During the beam prediction stage, data set division may refer to dividing the data, that is to be input into the beam prediction model, into different data sets for prediction of different receiving beam groups. Alternatively, in some cases, data set division may not be performed during the beam prediction stage, and the present disclosure is not limited thereto.

The beam pair identifier may be a beam pair ID or a beam pair index, which is used to identify the relative position of a corresponding beam pair among all beam pairs supported by the terminal. The beam quality corresponding to the beam pair identifier is indicative of the beam quality measured by the terminal on the corresponding beam pair.

In some embodiments, the beam pair ID may be embodied in a table.

For example, Table 1 provides a schematic table of beam pair IDs.

TABLE 1

| | | | Measured |
|---|---|---|---|
| Receiving | Transmitting | Beam | Quality of |
| Beam (RX) | Beam (TX) | Pair ID | Beam Pair |
| Receiving | Transmitting Beam 1 | 1 | R₁ |
| Beam 1 | . . . | . . . | . . . |
| | Transmitting Beam m | m | Rₘ |
| Receiving | Transmitting Beam 1 | m + 1 | Rₘ₊₁ |
| Beam 2 | . . . | . . . | . . . |
| | Transmitting Beam m | 2m | R₂ₘ |
| . . . | . . . | . . . | . . . |
| Receiving | Transmitting Beam 1 | (n − 1)m + 1 | R₍ₙ₋₁₎ₘ₊₁ |
| Beam n | . . . | . . . | . . . |
| | Transmitting Beam m | nm | Rₙₘ |

In some embodiments, the schematic table of beam pair IDs shown in Table 1 may be obtained by the terminal based on the measurement order of the beam pairs. For example, in the measurement process of beam pairs, the terminal selects to traverse all receiving beam groups and, under each receiving beam group, traverses all transmitting beams (TX), thereby arranging all beam pairs in order to form a specific beam pair ID table, that is, Table 1. Each beam pair ID corresponds to a specific receiving beam and a specific transmitting beam, and each beam pair ID corresponds to measurement quality of a beam pair.

In step S22, the beam quality data set is input into the beam prediction model.

In some embodiments, the terminal may input the beam quality data set determined in S21 into the beam prediction model to perform beam prediction, so as to obtain the optimal beam and/or the beam quality of beam pairs in the first receiving beam groups.

According to the present disclosure, input data of the beam prediction model can be preprocessed in the prediction stage, thereby reducing the calculation complexity of the beam prediction model and improving the accuracy of the results.

In the beam prediction method according to some embodiments of the present disclosure, the beam quality data set may further include at least one type of the following information: a terminal identifier; and a measurement timestamp.

In some embodiments, the terminal identifier may be a terminal ID or a terminal index, which is used to identify the terminal for performing beam measurement.

In some embodiments, the measurement timestamp may indicate the time when the terminal measures the partial beam pairs in the first receiving beam groups.

The input data set of the beam prediction model according to the present disclosure may further include at least one of the terminal identifier and the measurement timestamp, so that the beam prediction model can perform beam prediction in a targeted manner (for example, it can perform beam prediction for a specific time period or for a specific terminal), thereby increasing the application scope of the beam prediction model and improving the generalization of the beam prediction model.

In the beam prediction method according to some embodiments of the present disclosure, the first receiving beam groups include a plurality of receiving beam groups determined from the receiving beam groups corresponding to the receiving beams supported by the terminal based on a first predefined rule; and/or the second receiving beam groups include a plurality of receiving beam groups determined from the receiving beam groups corresponding to the receiving beams supported by the terminal based on a second predefined rule.

In some embodiments, the first receiving beam group may include a plurality of receiving beam groups determined from receiving beam groups corresponding to receiving beams supported by the terminal based on the first predefined rule.

For example, the terminal determines multiple receiving beam groups from the receiving beam groups corresponding to all or part of the receiving beams supported by the terminal as the first receiving beam groups.

In some embodiments, the second receiving beam groups may include a plurality of receiving beam groups determined from receiving beam groups corresponding to receiving beams supported by the terminal based on the second predefined rule.

For example, a device (terminal or network device) that trains the beam prediction model determines multiple receiving beam groups from the receiving beam groups corresponding to all or part of the receiving beams supported by the terminal as the second receiving beam groups.

It can be understood that the first predefined rule and the second predefined rule can be the same or different. In one case, the first predefined rule and the second predefined rule are the same, then accordingly, the first receiving beam groups and the second receiving beam groups are the same, including that the number of first receiving beam groups and the number of second receiving beam groups are the same. In another case, the first predefined rule and the second predefined rule are different, then accordingly, the first receiving beam groups and the second receiving beam groups are different, including that the number of first receiving beam groups and the number of second receiving beam groups are the same, but the corresponding receiving beam groups are different; or that the number of first receiving beam groups and the number of second receiving beam groups are different, and the corresponding receiving beam groups are also different.

According to the present disclosure, the first receiving beam groups and the second receiving beam groups can be determined based on the same or different predefined rules, so that the beam prediction model can use the same or different receiving beam groups in the training stage and the prediction stage. The beam prediction model is applicable to terminals that support different receiving beams, and has a wider scope of application.

In the beam prediction method according to some embodiments of the present disclosure, the first receiving beam groups include all of the multiple receiving beam groups determined based on the first predefined rule; and/or the second receiving beam groups include all of the multiple receiving beam groups determined based on the second predefined rule.

In some embodiments, the first receiving beam groups include all receiving beam groups in the plurality of receiving beam groups determined based on the first predefined rule.

For example, based on the first predefined rule, it is determined that 4 receiving beam groups can be used as the first receiving beam groups. Then, in the prediction stage of the beam prediction model, the first receiving beam groups used include all of 4 receiving beam groups determined based on the first predefined rule.

In some embodiments, the second receiving beam groups include all receiving beam groups in the plurality of receiving beam groups determined based on the second predefined rule.

For example, based on the second predefined rule, it is determined that 4 receiving beam groups can be used as the second receiving beam groups. Then, in the training stage of the beam prediction model, the second receiving beam groups used include all of 4 receiving beam groups determined based on the second predefined rule.

According to the present disclosure, all predetermined receiving beam groups are adopted in the training stage and the prediction stage of the beam prediction model, thereby ensuring that a better beam prediction model can be obtained through training in the training stage of the beam prediction model, and ensuring that fewer beam pairs are to be detected in the prediction stage of the beam prediction model, while ensuring that the predicted beams meet the requirements, so as to avoid waste of resources caused by detecting beam pairs in receiving beam groups that do not need to be predicted.

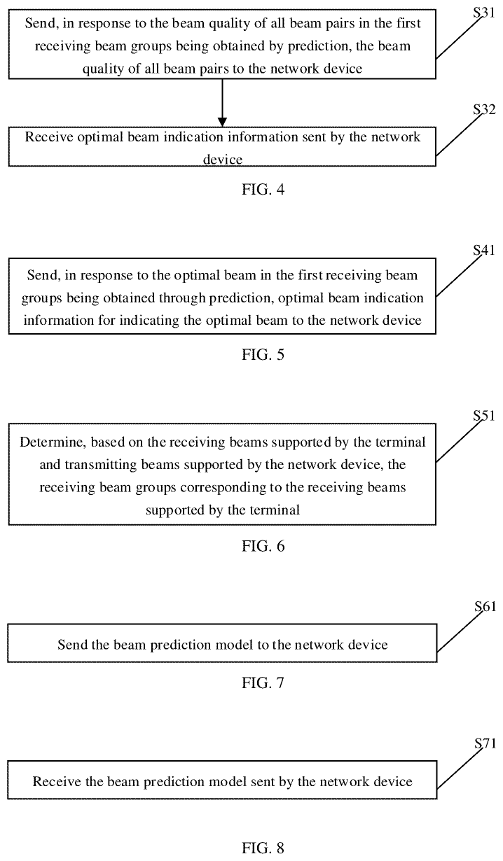

In the beam prediction method according to some embodiments of the present disclosure, FIG. 4 is a flow chart of another beam prediction method according to an exemplary embodiment. As shown in FIG. 4, the method may further include the following steps.

In step S31, in response to the beam quality of all beam pairs in the first receiving beam groups being obtained through prediction, the beam quality of all beam pairs is sent to the network device.

In some embodiments, if the output of the beam prediction model is the beam quality of all beam pairs in the first receiving beam groups, the terminal may send the beam quality of all beam pairs output by the beam prediction model to the network device.

In step S32, optimal beam indication information sent by the network device is received.

In some embodiments, the terminal may receive the optimal beam indication information sent by the network device, where the optimal beam indication information is indicative of the optimal beam.

It can be understood that the network device can determine the optimal beam based on the beam quality of all beam pairs sent by the terminal, and then send the optimal beam indication information for indicating the optimal beam to the terminal.

In the present disclosure, when the output of the beam prediction model is the beam quality of all beam pairs in the first receiving beam groups, the terminal can send the beam quality of all beam pairs to the network device, so that the network device can determine the optimal beam, thereby meeting the diversified service requirements of the beam prediction model.

In the beam prediction method according to some embodiments of the present disclosure, FIG. 5 is a flow chart of another beam prediction method according to an exemplary embodiment. As shown in FIG. 5, the method may further include the following steps.

In step S41, in response to the optimal beam in the first receiving beam groups being obtained through prediction, optimal beam indication information for indicating the optimal beam is sent to the network device.

In some embodiments, if the optimal beam can be output by the beam prediction model, the terminal can send the optimal beam indication information indicating the optimal beam to the network device. For example, the beam prediction model outputs the beam quality of the optimal beam, or the beam prediction model outputs an identifier of the optimal beam, where the identifier may be, for example, an ID or an index.

In the present disclosure, when the output of the beam prediction model is the optimal beam within the first receiving beam groups, the terminal can send the optimal beam indication information for indicating the optimal beam to the network device, so that the network device can determine the optimal beam, thereby meeting the diversified service requirements of the beam prediction model.

In the beam prediction method according to some embodiments of the present disclosure, FIG. 6 is a flow chart of another beam prediction method according to an exemplary embodiment. As shown in FIG. 6, the method may further include the following steps.

In step S51, based on the receiving beams supported by the terminal and transmitting beams supported by the network device, the receiving beam groups corresponding to the receiving beams supported by the terminal are determined.

In some embodiments, the terminal may divide the receiving beams based on the receiving beams supported by the terminal and the transmitting beams supported by the network device, so as to obtain the receiving beam groups corresponding to the receiving beams. Each of the receiving beam groups corresponds to one receiving beam. Each receiving beam group includes multiple beam pairs, and the multiple beam pairs correspond to different transmitting beams supported by the network device.

Optionally, after obtaining the receiving beam groups corresponding to the receiving beams supported by the terminal, the terminal can send group indication information for indicating the receiving beam groups to the network device, so that the network device can determine the division of the receiving beam groups.

According to the present disclosure, the receiving beam groups are obtained based on receiving beam division by the terminal, so that the beam prediction model can perform beam prediction based on different receiving beam groups, thereby reducing the overhead and delay of beam management. At the same time, it is also applicable to terminals that support different receiving beams, and has a wider range of applications.

In the beam prediction method according to some embodiments of the present disclosure, FIG. 7 is a flow chart of another beam prediction method according to an exemplary embodiment. As shown in FIG. 7, in response to the beam prediction model being pre-trained on the terminal, the method may further include the following steps.

In step S61, the beam prediction model is sent to the network device.

In some embodiments, if the beam prediction model is pre-trained on the terminal, the terminal sends the beam prediction model to the network device.

For example, the terminal obtains the beam prediction model through pre-training, and the terminal can send the beam prediction model to a base station or a cloud for storage.

In the present disclosure, if the terminal obtains the beam prediction model through pre-training, the beam prediction model can be sent to the base station or the cloud for storage, so that other terminals or network devices can use the beam prediction model to perform beam prediction, thereby reducing the overhead and latency of beam management.

In the beam prediction method according to some embodiments of the present disclosure, FIG. 8 is a flow chart of another beam prediction method according to an exemplary embodiment. As shown in FIG. 8, in response to the beam prediction model being pre-trained on the network device, the method may further include the following steps.

In step S71, a beam prediction model sent by a network device is received.

In some embodiments, if the beam prediction model is pre-trained on the network device, the terminal may receive the beam prediction model sent by the network device, so that the terminal can perform beam prediction using the beam prediction model.

The training stage and prediction stage of the beam prediction model in the present disclosure can be performed on different devices, so that the beam prediction model can be deployed and executed according to the actual device performance, thereby improving the operating efficiency of the beam prediction model.

Based on the same concept, the present disclosure also provides a method for a network device to perform beam prediction.

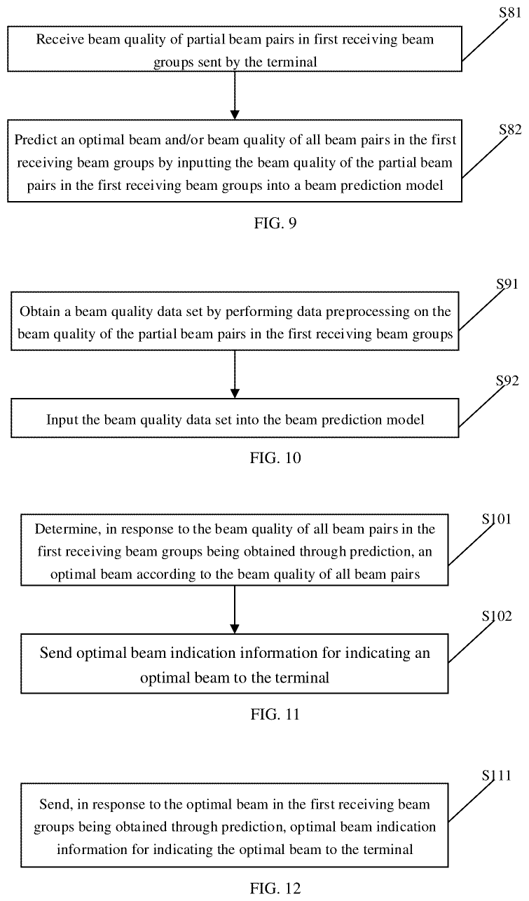

FIG. 9 is a flow chart of another beam prediction method according to an exemplary embodiment. As shown in FIG. 9, the method is applied to a network device and may include the following steps.

In step S81, beam quality of partial beam pairs in first receiving beam groups sent by a terminal is received.

In some embodiments, the network device may receive the beam quality of partial beam pairs in first receiving beam groups sent by the terminal. The first receiving beam groups are partial receiving beam groups in receiving beam groups corresponding to receiving beams supported by the terminal. It can be understood that the beam quality of the beam pair is measured by the terminal, so the network device is to receive the beam quality of the partial beam pairs in the first receiving beam groups measured by the terminal.

It can be understood that the receiving beam groups corresponding to the first receiving beam groups can be predefined.

In step S82, the beam quality of partial beam pairs in the first receiving beam groups are input into a beam prediction model to predict an optimal beam and/or beam quality of all beam pairs in the first receiving beam groups.

In some embodiments, the network device may input the beam quality of the partial beam pairs in the first receiving beam groups determined in S81 into the beam prediction model, so as to predict the optimal beam and/or the beam quality of all beam pairs in the first receiving beam groups. The beam prediction model is pre-trained based on beam quality of beam pairs in second receiving beam groups. The second receiving beam groups are partial receiving beam groups in the receiving beam groups corresponding to the receiving beams supported by the terminal, and the second receiving beam groups are the same as or different from the first receiving beam groups.

It can be understood that the receiving beam groups corresponding to the second receiving beam groups may be predefined. The second receiving beam groups and the first receiving beam groups may be the same one or more receiving beam groups, or may be different one or more receiving beam groups.

In some embodiments, when training the beam prediction model, all predefined second receiving beam groups can be used for training.

In some embodiments, the optimal beam may be a beam with the best beam quality when the terminal performs communication. The optimal beam may include at least one of an optimal transmitting beam, an optimal receiving beam, and an optimal beam pair. Here, the optimal beam pair includes a transmitting beam and a receiving beam. The beam quality of the beam may be considered to be the best when the beam quality meets a preset condition. The specific condition may be arbitrarily set according to actual situation, such as being higher than a certain threshold or lower than a certain threshold, or the like, which is not limited in this disclosure.

In some embodiments, the output of the beam prediction model may be the beam quality of all beam pairs in the first receiving beam groups. The output of the beam prediction model may be the beam quality of some beam pairs in the first receiving beam groups. The output of the beam prediction model may be the optimal beam corresponding to the first receiving beam groups.

According to the present disclosure, the beam prediction model, trained by using the beam quality of a small number of beam pairs, is used to predict the optimal beam and/or the beam quality of all beam pairs based on the beam quality of some measured beam pairs, thereby reducing the overhead and delay of beam management. It is also applicable to terminals that support different receiving beams, and has a wider range of applications.

In the beam prediction method according to some embodiments of the present disclosure, the number of first receiving beam groups are the same as or different from the number of second receiving beam groups; the number of first receiving beam groups is less than or equal to the number of receiving beam groups corresponding to the receiving beams supported by the terminal; and/or the number of second receiving beam groups is less than or equal to the number of receiving beam groups corresponding to the receiving beams supported by the terminal.

In some embodiments, it may be assumed that the number of receiving beams supported by the terminal is n, the number of first receiving beam groups may be recorded as n_test, and the number of second receiving beam groups may be recorded as n_train, where n_test and n_train may be the same or different.

In some embodiments, n_test is less than or equal to n, indicating that the network device can perform beam prediction based on some or all receiving beams supported by the terminal.

In some embodiments, n_test may be divisible by n, and 1-n_test-n.

In some embodiments, n_train is less than or equal to n, indicating that the beam prediction model is trained using some receiving beams supported by the terminal.

In some embodiments, n_train may be divisible by n, and 1-n_train-n.

The beam prediction model in the present disclosure can use the same number or different numbers of receiving beam groups in the prediction stage and the training stage, so that the beam prediction groups are applicable to terminals supporting different numbers of receiving beams, thereby achieving a wider range of applications. Moreover, in the training stage of the beam prediction model, training can be completed by using only some of the receiving beam groups supported by the terminal, thereby reducing the overhead of beam management.

In the beam prediction method according to some embodiments of the present disclosure, the beam quality of partial beam pairs in the first receiving beam groups is determined based on the following parameters: a predefined sampling rate; and measurement mode information corresponding to the first receiving beam groups configured by the terminal.

In some embodiments, the terminal may determine the beam quality of partial beam pairs in the first receiving beam groups based on a predefined sampling rate and measurement mode information corresponding to the first receiving beam groups configured by the terminal.

It can be understood that, the sampling rate k is a decimal between 0 and 1, or any value between 0 and 100%; and m is a positive integer.

In some embodiments, the sampling rate may be predefined by the terminal or the network device. If it is predefined by the terminal, the terminal may also send the sampling rate information to the network device. If it is predefined by the network device, the terminal may also receive the sampling rate information sent by the network device.

According to the present disclosure, only some beam pairs in the first receiving beam groups are to be measured through the sampling rate and measurement mode, so that the prediction of other beam quality and/or the optimal beam can be achieved by using some beam pairs, thereby reducing the overhead and delay of beam management.

In the beam prediction method according to some embodiments of the present disclosure, FIG. 10 is a flow chart of another beam prediction method according to an exemplary embodiment. As shown in FIG. 10, in S82, inputting the beam quality of the partial beam pairs in the first receiving beam groups into the pre-trained beam prediction model may include the following steps.

In step S91, data preprocessing is performed on the beam quality of the partial beam pairs in the first receiving beam groups to obtain a beam quality data set.

In some embodiments, the network device performs data preprocessing on the beam quality of partial beam pairs in the first receiving beam groups to obtain the beam quality data set, where the beam quality data set includes: a beam pair identifier; and beam quality corresponding to the beam pair identifier.

In step S92, the beam quality data set is input into the beam prediction model.

In some embodiments, the network device may input the beam quality data set determined in S91 into the beam prediction model to perform beam prediction, so as to obtain the optimal beam and/or the beam quality of beam pairs in the first receiving beam groups.

According to the present disclosure, input data of the beam prediction model can be preprocessed in the prediction stage, thereby reducing the calculation complexity of the beam prediction model and improving the accuracy of the results.

In the beam prediction method according to some embodiments of the present disclosure, the beam quality data set may further include at least one type of the following information: a terminal identifier; and a measurement timestamp.

In some embodiments, the terminal identifier may be a terminal ID or a terminal index, which is used to identify the terminal for performing beam measurement.

In some embodiments, the measurement timestamp may indicate the time when the terminal measures the partial beam pairs in the first receiving beam groups.

The input data set of the beam prediction model according to the present disclosure may further include at least one of the terminal identifier and the measurement timestamp, so that the beam prediction model can perform beam prediction in a targeted manner (for example, it can perform beam prediction for a specific time period or for a specific terminal), thereby increasing the application scope of the beam prediction model and improving the generalization of the beam prediction model.

In the beam prediction method according to some embodiments of the present disclosure, the first receiving beam groups include a plurality of receiving beam groups determined from the receiving beam groups corresponding to the receiving beams supported by the terminal based on a first predefined rule; and/or the second receiving beam groups include a plurality of receiving beam groups determined from the receiving beam groups corresponding to the receiving beams supported by the terminal based on a second predefined rule.

In some embodiments, the first receiving beam group may include a plurality of receiving beam groups determined from receiving beam groups corresponding to receiving beams supported by the terminal based on the first predefined rule.

In some embodiments, the second receiving beam groups may include a plurality of receiving beam groups determined from receiving beam groups corresponding to receiving beams supported by the terminal based on the second predefined rule.

It can be understood that the first predefined rule and the second predefined rule can be the same or different. In one case, the first predefined rule and the second predefined rule are the same, then accordingly, the first receiving beam groups and the second receiving beam groups are the same, including that the number of first receiving beam groups and the number of second receiving beam groups are the same. In another case, the first predefined rule and the second predefined rule are different, then accordingly, the first receiving beam groups and the second receiving beam groups are different, including that the number of first receiving beam groups and the number of second receiving beam groups are the same, but the corresponding receiving beam groups are different; or that the number of first receiving beam groups and the number of second receiving beam groups are different, and the corresponding receiving beam groups are also different.

According to the present disclosure, the first receiving beam groups and the second receiving beam groups can be determined based on the same or different predefined rules, so that the beam prediction model can use the same or different receiving beam groups in the training stage and the prediction stage. The beam prediction model is applicable to terminals that support different receiving beams, and has a wider scope of application.

In the beam prediction method according to some embodiments of the present disclosure, the first receiving beam groups include all of the multiple receiving beam groups determined based on the first predefined rule; and/or the second receiving beam groups include all of the multiple receiving beam groups determined based on the second predefined rule.

In some embodiments, the first receiving beam groups include all receiving beam groups in the plurality of receiving beam groups determined based on the first predefined rule.

In some embodiments, the second receiving beam groups include all receiving beam groups in the plurality of receiving beam groups determined based on the second predefined rule.

According to the present disclosure, all predetermined receiving beam groups are adopted in the training stage and the prediction stage of the beam prediction model, thereby ensuring that a better beam prediction model can be obtained through training in the training stage of the beam prediction model, and ensuring that fewer beam pairs are to be detected in the prediction stage of the beam prediction model, while ensuring that the predicted beams meet the requirements, so as to avoid waste of resources caused by detecting beam pairs in receiving beam groups that do not need to be predicted.

In the beam prediction method according to some embodiments of the present disclosure, FIG. 11 is a flow chart of another beam prediction method according to an exemplary embodiment. As shown in FIG. 11, the method may further include the following steps.

In step S101, in response to the beam quality of all beam pairs in the first receiving beam groups being obtained through prediction, an optimal beam is determined according to the beam quality of all beam pairs.

In some embodiments, if the output of the beam prediction model is the beam quality of all beam pairs in the first receiving beam groups, the network device may determine the optimal beam according to the beam quality of all beam pairs.

In step S102, optimal beam indication information for indicating the optimal beam is sent to the terminal.

In some embodiments, the network device may send the optimal beam indication information for indicating the optimal beam to the terminal.

It can be understood that the network device can determine the optimal beam based on the beam quality of all beam pairs, and then send the optimal beam indication information for indicating the optimal beam to the terminal, so that the terminal can perform communication based on the optimal beam.

In the present disclosure, when the output of the beam prediction model is the beam quality of all beam pairs in the first receiving beam groups, the network device can determine the optimal beam based on the beam quality of all beam pairs and send the optimal beam to the terminal, so that the terminal can perform communication based on the optimal beam, thereby meeting the diversified service requirements of the beam prediction model.

In the beam prediction method according to some embodiments of the present disclosure, FIG. 12 is a flow chart of another beam prediction method according to an exemplary embodiment. As shown in FIG. 12, the method may further include the following steps.

In step S111, in response to the optimal beam in the first receiving beam groups being obtained through prediction, optimal beam indication information for indicating the optimal beam is sent to the terminal.

In some embodiments, if the output of the beam prediction model is the optimal beam in the first receiving beam groups, the network device may send the optimal beam indication information for indicating the optimal beam to the terminal, so that the terminal can perform communication based on the optimal beam.

In the present disclosure, when the output of the beam prediction model is the optimal beam, the network device can send indication information for indicating the optimal beam to the terminal, so that the terminal can perform communication based on the optimal beam, thereby meeting the diversified service requirements of the beam prediction model.

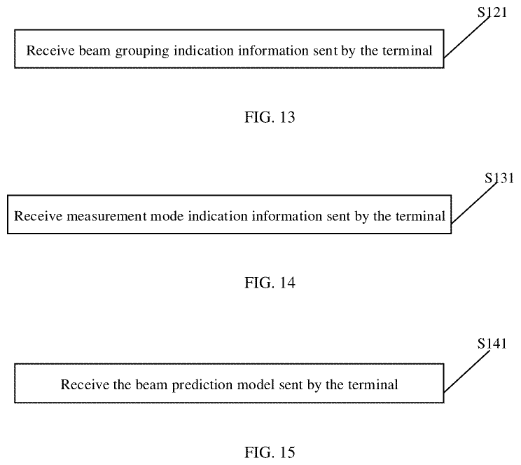

In the beam prediction method according to some embodiments of the present disclosure, FIG. 13 is a flow chart of another beam prediction method according to an exemplary embodiment. As shown in FIG. 13, the method may further include the following steps.

In step S121, beam group indication information sent by a terminal is received.

In some embodiments, the network device may receive the sent beam group indication information, where the beam group indication information is indicative of the receiving beam groups corresponding to the receiving beams supported by the terminal.

It can be understood that the receiving beam groups can be determined by the terminal based on the receiving beams supported by the terminal and transmitting beams supported by the network device. Each of the receiving beam groups corresponds to a receiving beam. Each receiving beam group includes multiple beam pairs, and the multiple beam pairs correspond to different transmitting beams supported by the network device.

According to the present disclosure, the receiving beam groups are determined based on the beam group indication information sent by the terminal, so that the beam prediction model can perform beam prediction based on different receiving beam groups, thereby reducing the overhead and delay of beam management. At the same time, it is also applicable to terminals that support different receiving beams, and has a wider range of applications.

In the beam prediction method according to some embodiments of the present disclosure, FIG. 14 is a flow chart of another beam prediction method according to an exemplary embodiment. As shown in FIG. 14, in response to the beam prediction model being pre-trained on the network device, the method may further include the following steps.

In step S131, measurement mode indication information sent by the terminal is received.

In some embodiments, if the beam prediction model is pre-trained on the network device, the network device may receive measurement mode indication information sent by the terminal, where the measurement mode indication information is indicative of the measurement mode configured by the terminal.

In some embodiments, the measurement mode configured by the terminal may be preset by the terminal.

It can be understood that the measurement mode configured by the terminal and used by the network device in the prediction stage of the beam prediction model is to be indicated by the terminal through corresponding indication information. If the training stage of the beam prediction model is also in the network device, the measurement mode configured by the terminal and used in the training stage is also to be indicated by the terminal through corresponding indication information. Optionally, the measurement mode configured by the terminal used in the prediction stage and the training stage of the beam prediction model can be the same measurement mode.

In the present disclosure, the network device can determine the measurement mode configured by the terminal according to the received measurement mode indication information for beam measurement or beam prediction model training, so that the beam prediction model can be run or trained on the network device, thereby improving the ability of the beam prediction model to be deployed on a variety of different devices.

In the beam prediction method according to some embodiments of the present disclosure, FIG. 15 is a flow chart of another beam prediction method according to an exemplary embodiment. As shown in FIG. 15, in response to the beam prediction model being pre-trained on the terminal, the method may further include the following steps.

In step S141, a beam prediction model sent by a terminal is received.

In some embodiments, if the beam prediction model is pre-trained on the terminal, the network device may receive the beam prediction model sent by the terminal, so that the network device may perform beam prediction using the beam prediction model.

The training stage and prediction stage of the beam prediction model in the present disclosure can be performed on different devices, so that the beam prediction model can be deployed and executed according to the actual device performance, thereby improving the operating efficiency of the beam prediction model.

The present disclosure will hereinafter describe the above-mentioned embodiments in combination with practical applications.

It can be understood that the execution process in the training stage of the beam prediction model is similar to that in the prediction stage. Therefore, the present disclosure will describe the training stage and the prediction stage of the beam prediction model in combination with practical applications.

The beam prediction method performed on the network device side in the above-mentioned FIG. 9 to FIG. 15 is similar to the beam prediction method performed on the terminal side in FIG. 2 to FIG. 8. The specific implementation process in each embodiment can refer to the corresponding description in FIG. 2 to FIG. 8, and the present disclosure will not repeat it again.

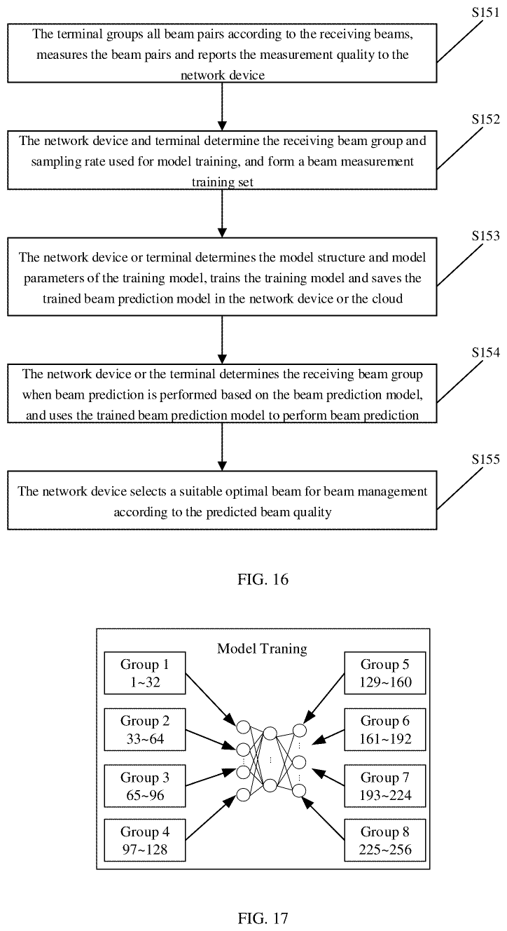

FIG. 16 is a flow chart of another beam prediction method according to an exemplary embodiment. As shown in FIG. 16, the method may include the following steps.

In step S151, the terminal groups all beam pairs according to receiving beams, measures the beam pairs and reports measurement quality to the network device.

In some embodiments, the terminal divides the beam pairs in the order of the receiving beam ID to form n non-intersecting receiving beam groups. It can be understood that the network device can also group the receiving beams in the same way. In some embodiments, the terminal can also receive the beam group indication information of the network device to determine the n receiving beam groups. After that, the terminal determines the measurement order of the beam pairs. For example, the terminal traverses all receiving beam groups to form a specific beam pair ID table shown in Table 1. Then, the terminal measures the reference signal to obtain the beam quality corresponding to each beam pair ID. For example, the measurement of beam quality is performed based on the CSI-RS/SSB reference signal. During the beam scanning process of the network device, the network device sends the CSI-RS/SSB reference signal to the user; the terminal measures the reference signal and obtains the beam quality of the beam direction by calculating the signal quality of the reference signal. The terminal can select L1-RSRP or L1-SINR as the criterion for determining the quality of the reference signal. Subsequently, the terminal reports the measurement quality of all beam pairs to the network device. For example, the beam quality reported by the terminal may include information such as a measurement timestamp, a beam pair ID table, and a measurement quality corresponding to each beam pair ID.

In step S152, the network device and the terminal determine the receiving beam groups and sampling rate used for model training, and form a beam measurement training set.

In some embodiments, the network device selects n_train receiving beam groups from n receiving beam groups as the training data set used for model training. For example, for the selection of n_train, a value that can be divided by n can be used as the value of n_train, where 1≤n_train<n. Then, the network device and the terminal determine the sampling rate of the beam measurement in each receiving beam group to facilitate the determination of the model structure. For example, in order to ensure that, when using the trained beam prediction model for beam prediction, the terminal only needs to measure the beam quality of some beam pairs to predict the beam quality of all beam pairs, k*m beam pairs can be selected from the receiving beam groups with a total of m beam pairs to be measured based on the sampling rate during training. The sampling rate is k (0<k<1), and the terminal measures the beam quality on k*m beam pairs and reports it to the network device. Other beam pairs that have not been selected are not measured to save resource overhead. It is worth noting that for each receiving beam group, the sampling rate may remain consistent to ensure the universality of the training model and reduce additional overhead. If the sampling rate is determined by the network device, the network device sends the sampling rate information to the terminal after determining the sampling rate in each receiving beam group. If the sampling rate is determined by the terminal itself, the terminal reports the sampling rate information to the network device after determining the sampling rate in each receiving beam group. Afterwards, in each receiving beam group, the terminal determines the measurement mode of k*m beam pairs that need to be measured from m beam pairs, and reports it to the network device. For example, after obtaining the sampling rate information, the terminal is to determine which k*m beam pairs to be measured from the m beam pairs, and report the beam pair IDs that need to be measured to the network device. Here, when the terminal determines the measurement mode of the beam pairs, a principle of uniform measurement can be followed, that is, k*m beam pairs are selected from the m beam pairs at fixed intervals. Then, the network device or terminal generates the beam measurement training set. The network device or terminal can index and integrate the beam quality reported by the terminal according to the selected receiving beam group IDs, the measurement mode determined by the terminal, and all beam pair IDs that need to be measured in the group, so as to generate the beam measurement training set.

In step S153, the network device or terminal determines the model structure and model parameters of the training model, trains the training model and saves the trained beam prediction model in the network device or the cloud.

In some embodiments, the network device or terminal performs data preprocessing to construct a beam measurement training set that can be used for model training. For example, the network device or terminal needs to perform data processing on the beam measurement training set determined in S102, including methods such as data inspection, data normalization, and data set partitioning, to form a beam measurement training set that can be used for model training. In some embodiments, the beam measurement training set may include information such as user ID, measurement timestamp, beam pair ID table, and measurement quality corresponding to the beam pair ID. Here, in the training stage of the beam prediction model, the data set division can be performed to form a training data set and a test data set. For another example, the network device or terminal is to divide the beam measurement training set into training data and training labels, where the training data is included in all selected receiving beam groups. The user determines the measurement quality of the beam pairs for beam measurement, and the training labels are included in all selected receiving beam groups, corresponding to the measurement quality of all beam pairs in the group. It can be understood that the receiving beam groups selected during training can be the second receiving beam groups.

Afterwards, the network device or terminal determines the model structure and model parameters of the training model. It can be understood that the training model is a model of the beam prediction model before training. For example, the network device or terminal can determine the model structure of the training model based on the sampling rate of the beam measurement (i.e., the number of beam pairs input to the model) as well as the specific training task characteristics and training requirements. Here, different training task characteristics and training requirements can be used to describe the beam quality or optimal beam of beams as the output of the beam prediction model.

In some embodiments, the model structure of the training model can be determined as follows.

For the determination process of the number of layers and nodes of the training model, followings may be referred to. The number of input layer nodes may be set to M′=k*m, which represents the number of measured beam pairs in the input model. This value is related to the sampling rate k and the number of transmitted beams m. The larger the sampling rate, the more beam pairs the user measures, the larger the number of input layer nodes is set. It can be understood that the maximum value of M′ is the same as m. The number of output layer nodes is set to N′=m, which depends on the number of transmitted beams m. The number of hidden layers is set to S, and the number of nodes in each hidden layer is set to L. Setting of the number of hidden layers may need to consider factors such as the size of the model and the generalization ability of the model.

For the process of determining the inter-layer connection mode, the full connection manner can be adopted between the hidden layer and the input layer, and the rectified liner unit (Relu) function can be used as the activation function. The full connection manner can be adopted between the hidden layers, and the Relu function can be used as the activation function. The partial connection manner can be adopted between the hidden layer and the output layer, and the Softmax function or Sigmoid function can be used as the activation function.

For the process of determining the loss function to be used, the mean square error (MSE) loss function, the mean absolute error (MAE) loss function, the Huber loss function, or the like can be used.

For the process of determining the hyperparameters of the training model, the number of learning rounds can be set to T. The setting of the number of learning rounds needs to weigh the influence of the model's training speed and training cost as well as the model's training accuracy. The learning rate can be set to a. Random weight initialization may be selected as the method of weight initialization.

Then, the network device or terminal trains the training model using the beam measurement training set. For example, the network device or terminal uses the training data in the beam measurement training set as the input of the model and uses the training labels in the beam measurement training set as the labels of the model output, where the label value represents the true value of the beam quality.

In some embodiments, the data of all the second receiving beam groups can be input into the model in a mixed manner. In other words, for the training data formed under different receiving beam groups, because their dimensional features are consistent, these data can be input into the training model in a shuffled order to improve the performance of the beam prediction model. Also, the training data on the n_train receiving beams can be input into the training model in batches.

For example, the network device or terminal calculates the training loss value based on the output result of the training model and the label value. If the mean square error loss function is used to calculate the training loss value, it can be shown as formula 1:

$$loss = \frac{1}{I} {\sum }_{i = 1}^{I} {( {y}_{i} - {\overline{y}}_{i} )}^{2} \qquad formula 1$$

Here, loss represents the loss value, I represents the amount of training data, yᵢ represents the output result of the training model for data i, and y̅ represents the label value of data i.

The network device or terminal updates the corresponding parameters of respective layers in the training model according to the loss value, model update method and hyperparameters. The model update method is, for example, stochastic gradient descent (SGD), Adam, or the like. The parameters in each layer of the training model are updated, for example, the parameters of the training model are updated using the SGD algorithm, as shown in formula 2:

$${x}_{t + 1} = {x}_{t} - {α}_{t} * ∇ {loss}_{t} \qquad formula 2$$

Here, xₜ represents the training model parameters to be updated in the t-th round, xₜ₊₁ represents the training model parameters after the t-th round update, ∇lossₜ represents the gradient of the loss value calculated in the t-th round, and at represents the learning rate in the t-th round.

Then, the training is performed in the above manner until the training model converges to obtain a trained beam prediction model. After the network device or terminal completes the training of the beam prediction model, the trained beam prediction model is saved in the network device or uploaded to the cloud.

It can be understood that the above steps S151 to S153 complete the training process of the beam prediction model. The training process can be run on a network device or on a terminal, which is not limited in the present disclosure.

In step S154, the network device or the terminal determines the receiving beam groups when the beam prediction model performs beam prediction, and uses the trained beam prediction model to perform beam prediction.

In some embodiments, the network device or terminal selects n_test receiving beam groups from n receiving beam groups as the data set used for beam prediction. For example, for the selection of n_test, a value that is divisible by n can be used as the value of n_test, where 1≤n_test≤n. It can be understood that the receiving beam groups selected in the beam prediction stage can be the above-mentioned first receiving beam groups. For example, the first receiving beam groups can be a subset of the second receiving beam groups, they may intersect with the second receiving beam groups, or may not intersect with the second receiving beam groups. If the network device is responsible for determining the first receiving beam groups, then after determining the first receiving beam groups, the network device sends all beam pair IDs contained in each group to the terminal, indicating the receiving beam used for beam prediction, so as to facilitate the terminal to determine the measurement mode of the beam pair.

Afterwards, the network device or terminal can use the trained beam prediction model to perform beam prediction.

In one case, beam prediction is done on the network device side.

The terminal selects a fixed number of beam pairs for beam measurement according to the beam pair IDs that need to be measured determined by the network device, and reports the measurement quality to the network device. The network device forms a beam measurement data set that can be used for beam prediction, and uses its trained beam prediction model to perform beam prediction, thereby predicting the optimal beam or the beam quality of all beam pairs under the n_test receiving beam groups.

Afterwards, the terminal determines the beam pair IDs of k*m beam pairs to be measured from the group of m beam pairs according to the sampling rate k set by the network device and the terminal during model training for each first receiving beam group. For example, the terminal determines the measurement mode of the beam pairs in accordance with the principle of uniform measurement, that is, k*m beam pairs are selected from the m beam pairs at fixed intervals.

Then, in each first receiving beam group, the user measures the quality of the reference signal on k*m beam pairs, and reports the measured beam quality and its corresponding beam pair IDs to the network device.

Afterwards, the network device compiles the first receiving beam group ID, the measurement mode determined by the terminal, and the beam quality reported by the terminal into a beam measurement data set for beam prediction.

Then, the network device performs data preprocessing to construct a beam measurement data set that can be used for beam prediction. For example, the network device is to perform data processing on the beam measurement data set used for beam prediction, including data inspection, data normalization, data set partitioning and other methods, to form the beam measurement data set that can be used for beam prediction. The beam measurement data set includes information such as user ID, measurement timestamp, beam pair ID table, and measurement quality corresponding to the beam pair ID.

Then, the network device uses its trained model to perform beam prediction and predicts the optimal beam or beam quality of all beam pairs among the n_test receiving beam groups.

In another case, beam prediction is completed on the terminal side.

The terminal first performs beam measurement and obtains the trained beam prediction model from the network device or the cloud. Alternatively, if the beam prediction model is completed on the terminal side, it is not necessary to obtain the beam prediction model. Then the trained beam prediction model is used to perform beam prediction, the optimal beam or beam quality of all beam pairs among the n_test receiving beam groups can be predicted, and the beam quality or optimal beam is reported to the network device.

Afterwards, the terminal determines the beam pair IDs of k*m beam pairs to be measured from the group of m beam pairs according to the set sampling rate k on each first receiving beam group. For example, the terminal determines the measurement mode of the beam pairs in accordance with the principle of uniform measurement, that is, k*m beam pairs are selected from the m beam pairs at fixed intervals.

Then, in each first beam pair group, the terminal measures the quality of the reference signals on k*m beam pairs, and integrates the measured beam quality and their corresponding beam pair IDs into a beam measurement data set for beam prediction.

After that, the user performs data preprocessing to construct a beam measurement data set that can be used for beam prediction. For example, the terminal is to perform data processing on the beam measurement data set, including data inspection, data normalization, data set division and other methods, to form a beam measurement data set that can be used for beam prediction. The beam measurement data set includes information such as user ID, measurement timestamp, beam pair ID table, and measurement quality corresponding to the beam pair ID.

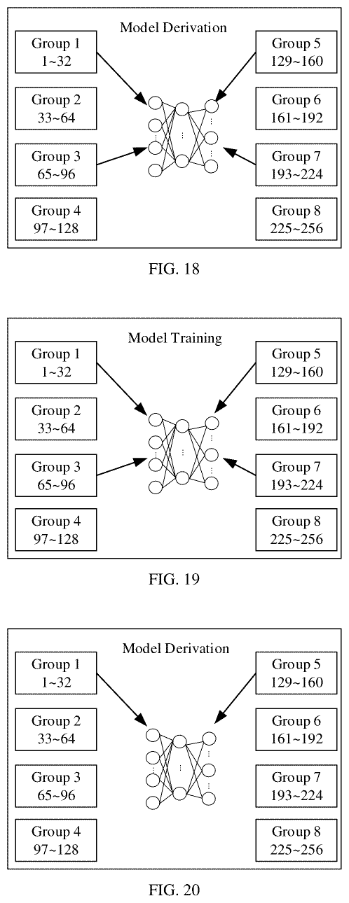

For example, a schematic diagram of beam prediction model training is shown in FIG. 17. In a scenario, the number of transmitting beams is 32, the number of receiving beams is 8, the number of receiving beam groups used for model training is 8, the number of receiving beam groups used for beam prediction is 4, and the sampling rate is 0.5. The data used in beam prediction model training can be obtained from all 8 receiving beam groups. For example, a schematic diagram of beam prediction model training is shown in FIG. 18. In the same scenario as FIG. 17, the data used by the beam prediction model for beam prediction can be obtained from 4 of the receiving beam groups, for example, group 1, group 3, group 5, and group 7.

For another example, FIG. 19 shows another schematic diagram of beam prediction model training. In a scenario, the number of transmitting beams is 32, the number of receiving beams is 8, the number of receiving beam groups used for model training is 4, the number of receiving beam groups used for beam prediction is 2, and the sampling rate is 0.5. The data used in beam prediction model training can be obtained from 4 of the receiving beam groups, for example, group 1, group 3, group 5, and group 7. For example, FIG. 20 shows another schematic diagram of beam prediction model training. In the same scenario as FIG. 19, the data used by the beam prediction model for beam prediction can be obtained from 2 of the receiving beam groups, for example, group 1 and group 5.

Then, the terminal obtains the trained beam prediction model from the network device or the cloud, and performs beam prediction using the trained beam prediction model based on the beam measurement data set that can be used for beam prediction, predicts the optimal beam or beam quality of all beam pairs among the n_test receiving beam groups, and reports the beam quality or optimal beam to the network device. Alternatively, if the beam prediction model is completed on the terminal side, it is not necessary to obtain the beam prediction model.

In step S155, the network device selects a suitable optimal beam for beam management according to the predicted beam quality.

In some embodiments, the network device obtains the beam quality of the beam pairs in the receiving beam groups for beam prediction. For example, the beam prediction model outputs the beam quality of the beam pairs, and the network device obtains the beam quality of the beam pairs. It can be understood that no matter whether the beam prediction is completed on the terminal side or the network device side, the network device may obtain the beam quality of all beam pairs in the determined n_test receiving beam groups.

Then, the network device selects the optimal beam. For example, the network device selects at least one reference signal ID with the best measurement quality from the beam quality covering all receiving beams as the optimal beam.

Afterwards, the network device indicates the optimal beam to the terminal. For example, the network device indicates the optimal beam to the user as a downlink transmission beam for beam management. Alternatively, if the beam prediction model directly outputs the optimal beam, the network device or the terminal can directly indicate the optimal beam to the other end.

In the above process, if the beam prediction is performed on the terminal side, after the beam prediction model training is completed, the terminal only needs to measure the beam quality of some beam pairs, and use the beam prediction model to predict the optimal beam or the measurement quality of all beam pairs, and report the optimal beam, that is, at least one reference signal ID corresponding to the best beam quality and the corresponding measurement quality to the network device. If the beam prediction is performed on the network device side, after the beam prediction model training is completed, the terminal only needs to measure the beam quality of some beam pairs, and report the beam quality of some beam pairs to the network device. The network device uses the beam prediction model to predict the optimal beam or the beam quality of all beam pairs of the terminal, and indicates the optimal beam, that is, at least one reference signal ID corresponding to the best beam quality, as a downlink transmission beam to the terminal.

According to the present disclosure, beam pairs are firstly grouped according to receiving beams. The same or different receiving beam groups can be used for model training and beam prediction. During model training, the training entity (network device or terminal) predicts the beam quality of all beam pairs based on the beam quality of some beam pairs of the terminal. Similarly, during beam prediction, the prediction entity (network device or terminal) also uses the beam quality of some beam pairs to predict the beam quality of all beam pairs, thereby avoiding the large amount of reference signal resource consumption and huge delay generated by the terminal measuring all beam pairs, and effectively reducing the overhead of beam management while ensuring the performance of beam management.

Taking into account factors such as terminal mobility, the terminal's beam measurement requirements will change significantly, including changes in the transmitting beam or the receiving beam. The present disclosure can adapt to the input of a variety of different numbers of beam pairs and support adjustment of the number of receiving beams, effectively ensuring the generalization performance of the model, thereby meeting diverse service requirements.

It should be noted that those skilled in the art can understand that the various implementation methods/embodiments involved in the embodiments of the present disclosure can be used in conjunction with the aforementioned embodiments or can be used independently. Whether used alone or in conjunction with the aforementioned embodiments, the implementation principle is similar. In the implementation of the present disclosure, some embodiments are described in terms of implementation methods used together. Optionally, those skilled in the art can understand that such examples are not limitations of the embodiments of the present disclosure.

Based on the same concept, the embodiments of the present disclosure also provide a beam prediction apparatus and device.

It is understandable that the beam prediction apparatus and device according to some embodiments of the present disclosure include hardware structures and/or software modules corresponding to the execution of each function in order to realize the above functions. In combination with the units and algorithm steps of each example disclosed in the embodiments of the present disclosure, the embodiments of the present disclosure can be implemented in the form of hardware or a combination of hardware and computer software. Whether a function is executed in the form of hardware or computer software driving hardware depends on the specific application and design constraints of the technical solution. Those skilled in the art may use different methods to implement the described functions for each specific application, but such implementation should not be considered to exceed the scope of the technical solution of the embodiments of the present disclosure.

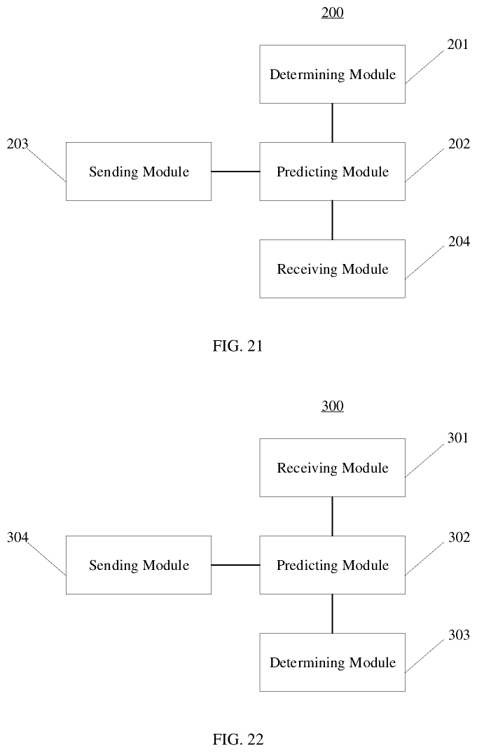

FIG. 21 is a schematic diagram of a beam prediction apparatus according to an exemplary embodiment. Referring to FIG. 21, the apparatus 200 is equipped in a terminal, and includes: a determining module 201, configured to determine beam quality of partial beam pairs in first receiving beam groups, where the first receiving beam groups are partial receiving beam groups in receiving beam groups corresponding to receiving beams supported by the terminal; a predicting module 202, configured to predict an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to the present disclosure, the beam prediction model, trained by using the beam quality of a small number of beam pairs, is used to predict the optimal beam and/or the beam quality of all beam pairs based on the beam quality of some measured beam pairs, thereby reducing the overhead and delay of beam management. It is also applicable to terminals that support different receiving beams, and has a wider range of applications.

In some embodiments, the number of first receiving beam groups is the same as or different from the number of second receiving beam groups; the number of first receiving beam groups is less than or equal to the number of receiving beam groups corresponding to the receiving beams supported by the terminal; and/or the number of second receiving beam groups is less than or equal to the number of receiving beam groups corresponding to the receiving beams supported by the terminal.

The beam prediction model in the present disclosure can use the same number or different numbers of receiving beam groups in the prediction stage and the training stage, so that the beam prediction groups are applicable to terminals supporting different numbers of receiving beams, thereby achieving a wider range of applications. Moreover, in the training stage of the beam prediction model, training can be completed by using only some of the receiving beam groups supported by the terminal, thereby reducing the overhead of beam management.

In some embodiments, the beam quality of partial beam pairs in the first receiving beam groups is determined based on the following parameters: a predefined sampling rate; and measurement mode information corresponding to the first receiving beam groups configured by the terminal.

According to the present disclosure, only some beam pairs in the first receiving beam groups are to be measured through the sampling rate and measurement mode, so that the prediction of other beam quality and/or the optimal beam can be achieved by using some beam pairs, thereby reducing the overhead and delay of beam management.

In some embodiments, the predicting module 202 is further configured to: perform data preprocessing on the beam quality of partial beam pairs in the first receiving beam groups to obtain a beam quality data set; and input the beam quality data set into the beam prediction model; where the beam quality data set includes: a beam pair identifier; and beam quality corresponding to the beam pair identifier.

According to the present disclosure, input data of the beam prediction model can be preprocessed in the prediction stage, thereby reducing the calculation complexity of the beam prediction model and improving the accuracy of the results.

In some embodiments, the beam quality data set further includes at least one type of the following information: a terminal identifier; and a measurement timestamp.

The input data set of the beam prediction model according to the present disclosure may further include at least one of the terminal identifier and the measurement timestamp, so that the beam prediction model can perform beam prediction in a targeted manner (for example, it can perform beam prediction for a specific time period or for a specific terminal), thereby increasing the application scope of the beam prediction model and improving the generalization of the beam prediction model.

In some embodiments, the first receiving beam groups include a plurality of receiving beam groups determined from the receiving beam groups corresponding to the receiving beams supported by the terminal based on a first predefined rule; and/or the second receiving beam groups include a plurality of receiving beam groups determined from the receiving beam groups corresponding to the receiving beams supported by the terminal based on a second predefined rule.

According to the present disclosure, the first receiving beam groups and the second receiving beam groups can be determined based on the same or different predefined rules, so that the beam prediction model can use the same or different receiving beam groups in the training stage and the prediction stage. The beam prediction model is applicable to terminals that support different receiving beams, and has a wider scope of application.

In some embodiments, the first receiving beam groups include all of the multiple receiving beam groups determined based on the first predefined rule; and/or the second receiving beam groups include all of the multiple receiving beam groups determined based on the second predefined rule.

According to the present disclosure, all predetermined receiving beam groups are adopted in the training stage and the prediction stage of the beam prediction model, thereby ensuring that a better beam prediction model can be obtained through training in the training stage of the beam prediction model, and ensuring that fewer beam pairs are to be detected in the prediction stage of the beam prediction model, while ensuring that the predicted beams meet the requirements, so as to avoid waste of resources caused by detecting beam pairs in receiving beam groups that do not need to be predicted.

In some embodiments, the apparatus 200 also includes: a sending module 203, configured to send, in response to the beam quality of all beam pairs in the first receiving beam groups being obtained through the predicting, the beam quality of all beam pairs to a network device; and a receiving module 204, configured to receive optimal beam indication information sent by the network device, where the optimal beam indication information is indicative of the optimal beam.

In the present disclosure, when the output of the beam prediction model is the beam quality of all beam pairs in the first receiving beam groups, the terminal can send the beam quality of all beam pairs to the network device, so that the network device can determine the optimal beam, thereby meeting the diversified service requirements of the beam prediction model.

In some embodiments, the apparatus 200 further includes: a sending module 203, configured to send, in response to the optimal beam in the first receiving beam groups being obtained through the predicting, optimal beam indication information, indicative of the optimal beam, to the network device.

In the present disclosure, when the output of the beam prediction model is the optimal beam within the first receiving beam groups, the terminal can send the optimal beam indication information for indicating the optimal beam to the network device, so that the network device can determine the optimal beam, thereby meeting the diversified service requirements of the beam prediction model.

In some embodiments, the determining module 201 is further configured to: determine, based on the receiving beams supported by the terminal and transmitting beams supported by a network device, the receiving beam groups corresponding to the receiving beams supported by the terminal.

According to the present disclosure, the receiving beam groups are obtained based on receiving beam division by the terminal, so that the beam prediction model can perform beam prediction based on different receiving beam groups, thereby reducing the overhead and delay of beam management. At the same time, it is also applicable to terminals that support different receiving beams, and has a wider range of applications.

In some embodiments, in response to the beam prediction model being pre-trained on the terminal, the apparatus 200 further includes: a sending module 203, configured to send the beam prediction model to the network device.

In the present disclosure, if the terminal obtains the beam prediction model through pre-training, the beam prediction model can be sent to the base station or the cloud for storage, so that other terminals or network devices can use the beam prediction model to perform beam prediction, thereby reducing the overhead and latency of beam management.

In some embodiments, in response to the beam prediction model being pre-trained on the network device, the apparatus 200 further includes: a sending module 203, configured to receive the beam prediction model sent by the network device.

The training stage and prediction stage of the beam prediction model in the present disclosure can be performed on different devices, so that the beam prediction model can be deployed and executed according to the actual device performance, thereby improving the operating efficiency of the beam prediction model.

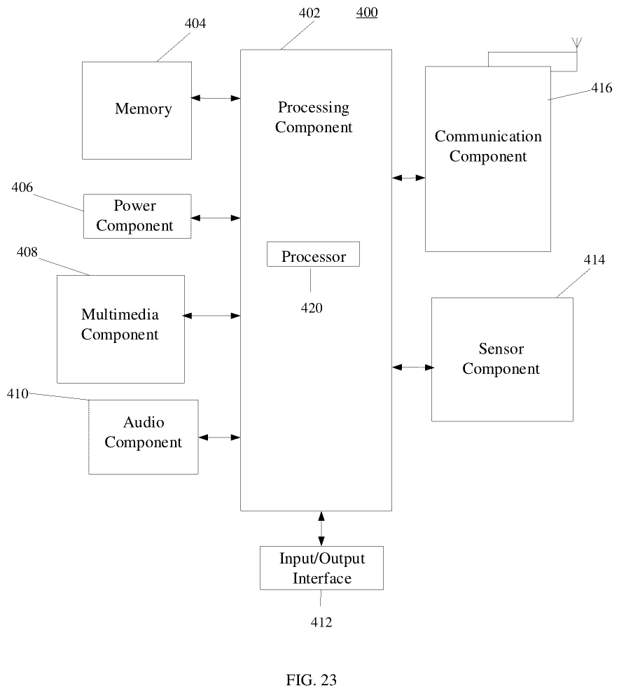

FIG. 22 is a schematic diagram of another beam prediction apparatus according to an exemplary embodiment. Referring to FIG. 22, the apparatus 300 is equipped in a network device, and includes: a receiving module 301, configured to receive beam quality of partial beam pairs in first receiving beam groups sent by a terminal, where the first receiving beam groups are partial receiving beam groups in receiving beam groups corresponding to receiving beams supported by the terminal; a predicting module 302, configured to predict an optimal beam and/or beam quality of all beam pairs in the first receiving beam groups by inputting the beam quality of the partial beam pairs in the first receiving beam groups into a beam prediction model; where the beam prediction model is obtained through pre-training based on beam quality of beam pairs in second receiving beam groups, the second receiving beam groups are partial receiving beam groups in the receiving beam groups corresponding to the receiving beams supported by the terminal, and the second receiving beam groups are same as or different from the first receiving beam groups.

According to the present disclosure, the beam prediction model, trained by using the beam quality of a small number of beam pairs, is used to predict the optimal beam and/or the beam quality of all beam pairs based on the beam quality of some measured beam pairs, thereby reducing the overhead and delay of beam management. It is also applicable to terminals that support different receiving beams, and has a wider range of applications.

In some embodiments, the number of first receiving beam groups are the same as or different from the number of second receiving beam groups; the number of first receiving beam groups is less than or equal to the number of receiving beam groups corresponding to the receiving beams supported by the terminal; and/or the number of second receiving beam groups is less than or equal to the number of receiving beam groups corresponding to the receiving beams supported by the terminal.

The beam prediction model in the present disclosure can use the same number or different numbers of receiving beam groups in the prediction stage and the training stage, so that the beam prediction groups are applicable to terminals supporting different numbers of receiving beams, thereby achieving a wider range of applications. Moreover, in the training stage of the beam prediction model, training can be completed by using only some of the receiving beam groups supported by the terminal, thereby reducing the overhead of beam management.

In some embodiments, the beam quality of partial beam pairs in the first receiving beam groups is determined based on the following parameters: a predefined sampling rate; and measurement mode information corresponding to the first receiving beam groups configured by the terminal.

According to the present disclosure, only some beam pairs in the first receiving beam groups are to be measured through the sampling rate and measurement mode, so that the prediction of other beam quality and/or the optimal beam can be achieved by using some beam pairs, thereby reducing the overhead and delay of beam management.

In some embodiments, the predicting module 302 is further configured to: perform data preprocessing on the beam quality of partial beam pairs within the first receiving beam groups to obtain a beam quality data set; and input the beam quality data set into the beam prediction model; where the beam quality data set includes: a beam pair identifier; and beam quality corresponding to the beam pair identifier.

According to the present disclosure, input data of the beam prediction model can be preprocessed in the prediction stage, thereby reducing the calculation complexity of the beam prediction model and improving the accuracy of the results.

In some embodiments, the beam quality data set further includes at least one type of the following information: a terminal identifier; and a measurement timestamp.

The input data set of the beam prediction model according to the present disclosure may further include at least one of the terminal identifier and the measurement timestamp, so that the beam prediction model can perform beam prediction in a targeted manner (for example, it can perform beam prediction for a specific time period or for a specific terminal), thereby increasing the application scope of the beam prediction model and improving the generalization of the beam prediction model.

In some embodiments, the first receiving beam groups include a plurality of receiving beam groups determined from the receiving beam groups corresponding to the receiving beams supported by the terminal based on a first predefined rule; and/or the second receiving beam groups include a plurality of receiving beam groups determined from the receiving beam groups corresponding to the receiving beams supported by the terminal based on a second predefined rule.

According to the present disclosure, the first receiving beam groups and the second receiving beam groups can be determined based on the same or different predefined rules, so that the beam prediction model can use the same or different receiving beam groups in the training stage and the prediction stage. The beam prediction model is applicable to terminals that support different receiving beams, and has a wider scope of application.

In some embodiments, the first receiving beam groups include all of the multiple receiving beam groups determined based on the first predefined rule; and/or the second receiving beam groups include all of the multiple receiving beam groups determined based on the second predefined rule.

According to the present disclosure, all predetermined receiving beam groups are adopted in the training stage and the prediction stage of the beam prediction model, thereby ensuring that a better beam prediction model can be obtained through training in the training stage of the beam prediction model, and ensuring that fewer beam pairs are to be detected in the prediction stage of the beam prediction model, while ensuring that the predicted beams meet the requirements, so as to avoid waste of resources caused by detecting beam pairs in receiving beam groups that do not need to be predicted.

In some embodiments, the apparatus 300 further includes: a determining module 303, configured to determine, in response to the beam quality of all beam pairs in the first receiving beam groups being obtained through the predicting, the optimal beam according to the beam quality of all beam pairs; and a sending module 304, configured to send optimal beam indication information for indicating the optimal beam to the terminal.

In the present disclosure, when the output of the beam prediction model is the beam quality of all beam pairs in the first receiving beam groups, the network device can determine the optimal beam based on the beam quality of all beam pairs and send the optimal beam to the terminal, so that the terminal can perform communication based on the optimal beam, thereby meeting the diversified service requirements of the beam prediction model.

In some embodiments, the apparatus 300 further includes: a sending module 304, configured to send, in response to the optimal beam in the first receiving beam groups being obtained through the predicting, optimal beam indication information for indicating the optimal beam to the terminal.

In the present disclosure, when the output of the beam prediction model is the optimal beam, the network device can send indication information for indicating the optimal beam to the terminal, so that the terminal can perform communication based on the optimal beam, thereby meeting the diversified service requirements of the beam prediction model.

In some embodiments, the receiving module 301 is further configured to: receive beam group indication information sent by the terminal, where the beam group indication information is indicative of the receiving beam groups corresponding to the receiving beams supported by the terminal.

According to the present disclosure, the receiving beam groups are determined based on the beam group indication information sent by the terminal, so that the beam prediction model can perform beam prediction based on different receiving beam groups, thereby reducing the overhead and delay of beam management. At the same time, it is also applicable to terminals that support different receiving beams, and has a wider range of applications.

In some embodiments, in response to the beam prediction model being pre-trained on the network device, the receiving module 301 is further configured to: receive measurement mode indication information sent by the terminal, where the measurement mode indication information is indicative of the measurement mode configured by the terminal.

In the present disclosure, the network device can determine the measurement mode configured by the terminal according to the received measurement mode indication information for beam measurement or beam prediction model training, so that the beam prediction model can be run or trained on the network device, thereby improving the ability of the beam prediction model to be deployed on a variety of different devices.

In some embodiments, in response to the beam prediction model being pre-trained on the terminal, the receiving module 301 is further configured to: receive the beam prediction model sent by the terminal.

The training stage and prediction stage of the beam prediction model in the present disclosure can be performed on different devices, so that the beam prediction model can be deployed and executed according to the actual device performance, thereby improving the operating efficiency of the beam prediction model.

Regarding the apparatus in the above embodiments, the specific manner in which each module performs operations has been described in detail in the embodiments of the method, and will not be elaborated here.

FIG. 23 is a schematic diagram of a beam prediction device according to an exemplary embodiment. For example, the device 400 may be a mobile phone, a computer, a digital broadcast terminal, a messaging device, a game console, a tablet device, a medical device, a fitness device, a personal digital assistant, and the like.

As shown in FIG. 23, device 400 may include one or more of the following components: processing component 402, memory 404, power component 406, multimedia component 408, audio component 410, input/output (I/O) interface 412, sensor component 414, and communication component 416.

The processing component 402 generally controls the overall operation of the device 400, such as operations associated with display, phone calls, data communications, camera operations, and recording operations. The processing component 402 may include one or more processors 420 to execute instructions to perform all or some of the steps of the methods described above. Additionally, the processing component 402 may include one or more modules that facilitate interaction between the processing component 402 and other components. For example, the processing component 402 may include a multimedia module to facilitate interaction between the multimedia component 408 and the processing component 402.

The memory 404 is configured to store various types of data to support operation at the device 400. Examples of such data include instructions, contact data, phonebook data, messages, pictures, videos, and the like for any application or method operating on the device 400. The memory 404 may be implemented by any type of volatile or non-volatile storage device or combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic or optical disk.

The power component 406 provides power to various components of the device 400. The power component 406 may include a power management system, one or more power sources, and other components associated with generating, managing, and distributing power to the device 400.

The multimedia component 408 includes a screen that provides an output interface between the device 400 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. The touch sensor may not only sense the boundaries of a touch or swipe action, but also detect the duration and pressure associated with the touch or swipe action. In some embodiments, the multimedia component 408 includes a front camera and/or a rear camera. When the device 400 is in an operation mode, such as a shooting mode or a video mode, the front camera and/or the rear camera may receive external multimedia data. Each of the front and rear cameras may be a fixed optical lens system or have focal length and optical zoom capability.

The audio component 410 is configured to output and/or input audio signals. For example, the audio component 410 includes a microphone (MIC) that is configured to receive external audio signals when the device 400 is in operating modes, such as calling mode, recording mode, and voice recognition mode. The received audio signal may be further stored in the memory 404 or transmitted via the communication component 416. In some embodiments, the audio component 410 also includes a speaker for outputting audio signals.

The I/O interface 412 provides an interface between the processing component 402 and a peripheral interface module, which may be a keyboard, a click wheel, a button, or the like. These buttons may include, but are not limited to: home button, volume buttons, start button, and lock button.

The sensor assembly 414 includes one or more sensors for providing status assessments of various aspects of the device 400. For example, the sensor assembly 414 can detect the open/closed state of the device 400, the relative positioning of components, such as the display and keypad of the device 400. The sensor assembly 414 can also detect a change in the position of the device 400 or a component of the device 400, the presence or absence of user contact with the device 400, the orientation or acceleration/deceleration of the device 400, and the temperature change of the device 400. The sensor assembly 414 may include a proximity sensor configured to detect the presence of nearby objects in the absence of any physical contact. The sensor assembly 414 may also include a light sensor, such as a CMOS or CCD image sensor, for use in imaging applications. In some embodiments, the sensor assembly 414 may also include an acceleration sensor, a gyroscope sensor, a magnetic sensor, a pressure sensor, or a temperature sensor.

The communication component 416 is configured to facilitate wired or wireless communication between the device 400 and other devices. The device 400 may access wireless networks based on communication standards, such as WiFi, 2G or 3G, or a combination thereof. In some embodiments, the communication component 416 receives broadcast signals or broadcast related information from an external broadcast management system via a broadcast channel. In some embodiments, the communication component 416 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In some embodiments, the device 400 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components, which are configured to perform the forgoing methods.

In some embodiments, there is also provided a non-transitory computer-readable storage medium including instructions, such as the memory 404 including instructions, executable by the processor 420 of the device 400 to perform the method described above. For example, the non-transitory computer-readable storage medium may be ROM, random access memory (RAM), CD-ROM, magnetic tape, floppy disk, optical data storage device, and the like.

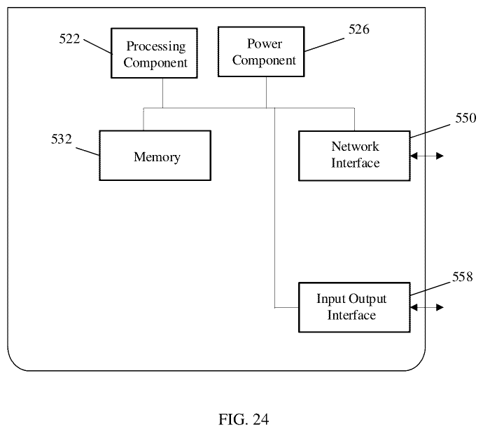

FIG. 24 is a block diagram of another beam prediction device according to an exemplary embodiment. For example, the device 500 may be provided as a base station or a server. Referring to FIG. 24, the device 500 includes a processing component 522, which further includes one or more processors; and a memory resource represented by memory 532 for storing instructions executable by the processing component 522, such as application programs. The application program stored in memory 532 may include one or more modules each corresponding to a set of instructions. In addition, the processing component 522 is configured to execute instructions to perform any foregoing methods.

The device 500 may also include a power component 526 configured to perform power management of the device 500, a wired or wireless network interface 550 configured to connect the device 500 to a network, and an input-output (I/O) interface 558. The device 500 can operate based on an operating system stored in the memory 532, such as Windows Server™, Mac OS X™, Unix™, Linux™, FreeBSD™ or the like.

According to the present disclosure, the overhead and latency of beam management can be effectively reduced while ensuring the performance of beam management; moreover, the generalization performance of the model for different numbers of receiving beams can be improved. Compared with related technologies, the present disclosure can improve the generalization of the model, effectively deal with the differences in the number of receiving beams of the terminal, and meet diverse service requirements.

According to the present disclosure, a neural network model can be trained based on AI technology. The terminal only needs to measure the beam quality of a few beam pairs, and can use the neural network model to predict the optimal beam or the beam quality of all beam pairs, thereby reducing the overhead and delay of beam management.

In the present disclosure, the beam pairs are grouped, and the receiving beam groups used in model training and beam prediction can be consistent or inconsistent. Depending on the task requirements, different numbers of beam pairs can be flexibly adapted to improve the generalization performance of the model.

The impact of this disclosure on existing protocols may include:
the terminal is to report the beam quality to the network device, the data format of the beam quality is to be unified, and the receiving beam ID is to be identified, so as to facilitate the beam prediction model to identify the receiving beam groups;
if the beam prediction is completed on the terminal side, the terminal is to report the receiving beam groups it uses to the network device and request the base station to send the trained beam prediction model;
the beam prediction model is to be updated in a timely manner between network device and terminal;
the network device and the terminal are to determine in advance information such as the sampling rate of the terminal for beam measurement, so that the network device or the terminal can determine the input of the training model.

It is further understood that in the present disclosure, “multiple/plurality” refers to two or more than two, and other quantifiers are similar thereto. “And/or” describes the association relationship of associated objects, indicating that three relationships may exist. For example, A and/or B may represent: A exists alone, both A and B exist, and B exists alone. The character “/” generally indicates that the associated objects before and after are in an “or” relationship. The singular forms “a”, “the”, and “said” are also intended to include plural forms, unless the context clearly indicates other meanings.

It is further understood that the terms “first”, “second”, and the like are used to describe various information, but such information should not be limited to these terms. These terms are only used to distinguish the same type of information from each other, and do not indicate a specific order or degree of importance. In fact, the expressions “first”, “second”, and the like can be used interchangeably. For example, without departing from the scope of the present disclosure, the first information can also be referred to as the second information, and similarly, the second information can also be referred to as the first information.

It is further understood that the meanings of the words “in response to” and “if” involved in the present disclosure depend on the context and the actual usage scenario. For example, the word “in response to” used herein can be interpreted as “when . . . ” or “upon . . . ” or “if” or “in case”.

It is further understood that, although the operations are described in a specific order in the drawings in the embodiments of the present disclosure, it should not be understood as requiring the operations to be performed in the specific order shown or in a serial order, or requiring the execution of all the operations shown to obtain the desired results. In certain environments, multitasking and parallel processing may be advantageous.

Other embodiments of this disclosure will be readily apparent to those skilled in the art from consideration of the specification and practice of the invention disclosed herein. This application is intended to cover any modification, use or adaptation of this disclosure, and these modifications, uses or adaptations follow the general principles of this disclosure and include common knowledge or conventional technical means in the art, which are not disclosed here.

It should be understood that this disclosure is not limited to the precise constructions which have been described above and shown in the drawings, and various modifications and changes may be made without departing from the scope thereof. The scope of this disclosure is limited only by the scope of the appended claims.

1. A beam prediction method, wherein the method is performed by a terminal and comprises:
determining beam quality of partial beam pairs in first receiving beam groups, wherein the first receiving beam groups belong to receiving beam groups corresponding to receiving beams supported by the terminal; and
predicting an optimal beam or beam quality of all beam pairs in the first receiving beam groups by inputting the beam quality of the partial beam pairs in the first receiving beam groups into a beam prediction model;
wherein the beam prediction model is obtained through pre-training based on beam quality of beam pairs in second receiving beam groups, the second receiving beam groups belong to the receiving beam groups corresponding to the receiving beams supported by the terminal, and the second receiving beam groups are same as or different from the first receiving beam groups.

2. The method according to claim 1, further comprising one of:
a number of the first receiving beam groups being same as or different from a number of the second receiving beam groups;
the number of the first receiving beam groups being less than or equal to a number of the receiving beam groups corresponding to the receiving beams supported by the terminal; or
the number of the second receiving beam groups being less than or equal to the number of the receiving beam groups corresponding to the receiving beams supported by the terminal.

3. The method according to claim 1, wherein the beam quality of the partial beam pairs in the first receiving beam groups is determined based on:
a predefined sampling rate; and
measurement mode information corresponding to the first receiving beam groups configured by the terminal.

4. The method according to claim 1, wherein inputting the beam quality of the partial beam pairs in the first receiving beam groups into the beam prediction model comprises:
obtaining a beam quality data set by performing data preprocessing on the beam quality of the partial beam pairs in the first receiving beam groups; and
inputting the beam quality data set into the beam prediction model;
wherein the beam quality data set comprises:
a beam pair identifier; and
beam quality corresponding to the beam pair identifier.

5. The method according to claim 4, wherein the beam quality data set further comprises at least one of:
a terminal identifier; or
a measurement timestamp.

6. The method according to claim 1, wherein the first receiving beam groups comprise multiple receiving beam groups determined, based on a first predefined rule, from the receiving beam groups corresponding to the receiving beams supported by the terminal; or
the second receiving beam groups comprise multiple receiving beam groups determined, based on a second predefined rule, from the receiving beam groups corresponding to the receiving beams supported by the terminal.

7. (canceled)

8. The method according to claim 1, further comprising:
sending, in response to the beam quality of all beam pairs in the first receiving beam groups being obtained through the predicting, the beam quality of all beam pairs to a network device; and receiving optimal beam indication information sent by the network device, wherein the optimal beam indication information is indicative of the optimal beam; or
sending, in response to the optimal beam in the first receiving beam groups being obtained through the predicting, optimal beam indication information, indicative of the optimal beam, to a network device.

9. (canceled)

10. The method according to claim 1, further comprising:
determining, based on the receiving beams supported by the terminal and transmitting beams supported by a network device, the receiving beam groups corresponding to the receiving beams supported by the terminal.

11. The method according to claim 1, further comprising:
sending, in response to the beam prediction model being obtained through pre-training on the terminal, the beam prediction model to a network device; or
receiving, in response to the beam prediction model being obtained through pre-training on a network device, the beam prediction model sent by the network device.

12. (canceled)

13. A beam prediction method, wherein the method is performed by a network device and comprises:
receiving beam quality of partial beam pairs in first receiving beam groups sent by a terminal, wherein the first receiving beam groups belong to receiving beam groups corresponding to receiving beams supported by the terminal; and
predicting an optimal beam or beam quality of all beam pairs in the first receiving beam groups by inputting the beam quality of the partial beam pairs in the first receiving beam groups into a beam prediction model;
wherein the beam prediction model is obtained through pre-training based on beam quality of beam pairs in second receiving beam groups, the second receiving beam groups belong to the receiving beam groups corresponding to the receiving beams supported by the terminal, and the second receiving beam groups are same as or different from the first receiving beam groups.

14. The method according to claim 13, further comprising one of:
a number of the first receiving beam groups being same as or different from a number of the second receiving beam groups;
the number of the first receiving beam groups being less than or equal to a number of the receiving beam groups corresponding to the receiving beams supported by the terminal; or
the number of the second receiving beam groups being less than or equal to the number of the receiving beam groups corresponding to the receiving beams supported by the terminal.

15. The method according to claim 13, wherein the beam quality of the partial beam pairs in the first receiving beam groups is determined based on:
a predefined sampling rate; and
measurement mode information corresponding to the first receiving beam groups configured by the terminal.

16. The method according to claim 13, wherein inputting the beam quality of the partial beam pairs in the first receiving beam groups into the beam prediction model comprises:
obtaining a beam quality data set by performing data preprocessing on the beam quality of the partial beam pairs in the first receiving beam groups; and
inputting the beam quality data set into the beam prediction model;
wherein the beam quality data set comprises:
a beam pair identifier; and
beam quality corresponding to the beam pair identifier.

17. The method according to claim 16, wherein the beam quality data set further comprises at least one of:
a terminal identifier; or
a measurement timestamp.

18. The method according to claim 13, wherein the first receiving beam groups comprise multiple receiving beam groups determined, based on a first predefined rule, from the receiving beam groups corresponding to the receiving beams supported by the terminal; or
the second receiving beam groups comprise multiple receiving beam groups determined, based on a second predefined rule, from the receiving beam groups corresponding to the receiving beams supported by the terminal.

19. (canceled)

20. The method according to claim 13, further comprising:
determining, in response to the beam quality of all beam pairs in the first receiving beam groups being obtained through the predicting, the optimal beam according to the beam quality of all beam pairs; and sending optimal beam indication information for indicating the optimal beam to the terminal; or
sending, in response to the optimal beam in the first receiving beam groups being obtained through the predicting, optimal beam indication information for indicating the optimal beam to the terminal.

21. (canceled)

22. The method according to claim 13, further comprising:
receiving beam group indication information sent by the terminal, wherein the beam group indication information is indicative of the receiving beam groups corresponding to the receiving beams supported by the terminal.

23. The method according to claim 13, further comprising:
receiving, in response to the beam prediction model being obtained through pre-training on the network device, measurement mode indication information sent by the terminal, wherein the measurement mode indication information is indicative of a measurement mode configured by the terminal; or
receiving, in response to the beam prediction model being obtained through pre-training on the terminal, the beam prediction model sent by the terminal.

24.-26. (canceled)

27. A terminal, comprising:
a processor; and
a memory, configured to store instructions executable by the processor;
wherein, the processor is configured to:
determine beam quality of partial beam pairs in first receiving beam groups, wherein the first receiving beam groups belong to receiving beam groups corresponding to receiving beams supported by the terminal; and
predict an optimal beam or beam quality of all beam pairs in the first receiving beam groups by inputting the beam quality of the partial beam pairs into a beam prediction model;
wherein the beam prediction model is obtained through pre-training based on beam quality of beam pairs in second receiving beam groups, the second receiving beam groups belong to the receiving beam groups corresponding to the receiving beams supported by the terminal, and the second receiving beam groups are same as or different from the first receiving beam groups.

28. A network device, comprising:
a processor; and
a memory, configured to store instructions executable by the processor;
wherein the processor is configured to implement the method according to claim 13.

29. (canceled)

30. (canceled)
